(19) United States
(12) Patent Application Publication
(10) Pub. No.: US 2026/0235977 A1
(43) Pub. Date: Aug. 13, 2026

(54) IMAGE FORMING APPARATUS

(71) Applicant: CANON KABUSHIKI KAISHA, Tokyo (JP)

(72) Inventor: NAOKI KANNO, Kanagawa (JP)

(21) Appl. No.: 19/538,385

(22) Filed: Feb. 12, 2026

(30) Foreign Application Priority Data
Feb. 13, 2025 (JP) 2025-021937

(51) Int. Cl. G03G 15/08

(52) U.S. Cl. CPC G03G 15/0868; G03G 15/0872

(57) ABSTRACT

An image forming apparatus includes a photosensitive drum, a plurality of toner cartridges, a rotary, a main body, a driving device, a reading portion, and a controller. In a case where a state of request information is a first state, the controller takes a preparation state, in which an image forming operation is executable, after a reading operation is executed. In a case where the state of request information is a second state, the controller takes the preparation state without executing the reading operation.

### BACKGROUND

### Field of the Technology

The present disclosure relates to an image forming apparatus using a rotary development type, and particularly relates to exchange control of a toner cartridge.

### Description of the Related Art

In an image forming apparatus of an electrophotographic type, the rotary development type in which a color image is formed by rotating a rotary provided with a plurality of developing rollers is known. In Japanese Laid-Open Patent Application (JP-A) No. 2007-183305, an image forming apparatus including a toner in which a plurality of developing devices provided with developing rollers are accommodated and a plurality of toner cartridges detachably mountable to the plurality of developing devices, respectively, is disclosed. In JP-A No. 2018-205697, a storing device in which an image forming condition optimized for each of toner cartridges is stored is provided. The image forming apparatus reads the image forming condition from the storing device during toner cartridge exchange and carries out image formation control on the basis of the read image forming condition.

In the case where a time required for an operation performed until a state of the image forming apparatus becomes a printable state is long, usability lowers.

### SUMMARY

The present disclosure has been accomplished in view of the above-described circumstances and is directed to improve usability by reducing a time required for an operation performed until a state of an image forming apparatus becomes a printable state.

According to an aspect of the present disclosure, there is provided an image forming apparatus configured to execute an image forming operation for forming an image on a recording material, the image forming apparatus comprising: a photosensitive drum; a plurality of toner cartridges each including a cartridge storing portion in which cartridge information is stored; a rotary to which the plurality of toner cartridges are detachably mounted, the rotary being rotatable and including a plurality of developing devices each including a developing roller and configured to accommodate toner supplied from corresponding one of the plurality of toner cartridges; a main body accommodating the rotary and provided with an opening, the main body including a main body storing portion which is a non-volatile memory and is configured to store request information; a driving device including at least one driving source, the driving device being configured to move each of the plurality of toner cartridges from an inside to an outside of the main body through the opening and configured to rotate the rotary so that the rotary takes an exchange position and a reading position, wherein movement of either one of the plurality of toner cartridges to the outside of the main body is permitted when the rotary is in the exchange position, and a reading operation of the cartridge storing portion of either one of the plurality of toner cartridges is permitted when the rotary is in the reading position; a reading portion; and a controller configured to control the driving device and configured to perform the reading operation through the reading portion, the controller determining whether or not the reading operation is executed on the basis of the request information, wherein in a case where a state of the request information is a first state, the controller takes a preparation state, in which the image forming operation is executable, after the reading operation is executed, and wherein in a case where the state of the request information is a second state, the controller takes the preparation state without executing the reading operation.

According to another aspect of the present disclosure, there is provided an image forming apparatus configured to execute an image forming operation for forming an image on a recording material, the image forming apparatus comprising: a photosensitive drum; a plurality of toner cartridges each including a cartridge storing portion in which cartridge information is stored; a rotatable rotary to which the plurality of toner cartridges are detachably mounted and which includes a plurality of developing devices each including a developing roller and configured to accommodate toner supplied from corresponding one of the plurality of toner cartridges; a main body accommodating the rotary and provided with an opening, the main body including a main body storing portion which is a non-volatile memory and is configured to store request information; a driving device including at least one driving source, the driving device being configured to move each of the plurality of toner cartridges from an inside to an outside of the main body through the opening and configured to rotate the rotary so that the rotary takes an exchange position and a reading position of each of the plurality of toner cartridges, wherein movement of either one of the plurality of toner cartridges to the outside of the main body is permitted when the rotary is in the exchange position, and a reading operation of the cartridge storing portion of either one of the plurality of toner cartridges is permitted when the rotary is in the reading position; a reading portion; and a controller configured to control the driving device and configured to perform the reading operation through the reading portion, the controller determining whether or not the reading operation is executed on the basis of the request information, wherein in a case where a power source of the image forming apparatus is turned off and in a case where the power source of the image forming apparatus is turned on from a turned-off state, a state of the request information is held, and wherein in a case where the power source of the image forming apparatus is turned-on from the turned-off state after the image forming operation is executed, the controller takes a preparation state, in which the image forming operation is executable, without executing the reading operation.

Features of the present disclosure will become apparent from the following description of embodiments with reference to the attached drawings. The following description of embodiments are described by way of example.

### BRIEF DESCRIPTION OF THE DRAWINGS

FIG. 1 is a sectional view showing an image forming apparatus of embodiments 1 and 2.

FIG. 2 is a sectional view of a toner cartridge and a developing unit in the embodiments 1 and 2.

Parts (a) and (b) of FIG. 3 are sectional views each of a rotary and a periphery thereof in the embodiments 1 and 2.

FIG. 4 is a schematic view of an outer appearance of the rotary in the embodiments 1 and 2.

Parts (a), (b), and (c) of FIG. 5 are schematic views each of an outer appearance of an image forming apparatus main assembly in the embodiments 1 and 2.

FIG. 6 is a sectional view of the rotary and the periphery thereof during exchange of the toner cartridge in the embodiments 1 and 2.

FIG. 7 is a perspective view showing a tray arrangement in the rotary in the embodiments 1 and 2.

FIG. 8 is a sectional view showing the tray arrangement in the rotary in the embodiments 1 and 2.

Parts (a) and (b) of FIG. 9 are perspective views showing a drive configuration of insertion/extraction of a tray in the embodiments 1 and 2.

Parts (a) and (b) of FIG. 10 are sectional views showing the drive configuration of the insertion/extraction of the tray in the embodiments 1 and 2.

Parts (a) and (b) of FIG. 11 are a perspective view and a schematic view, respectively, showing a configuration of a cartridge memory and a memory reading portion in the embodiments 1 and 2.

FIG. 12 is a schematic view showing an arrangement of the memory reading portion in the embodiments 1 and 2.

FIG. 13 is a block diagram of a printer main body in the embodiment 1.

Parts (a) to (c) of FIG. 14 are timing charts before and after turning-off of a power source in the embodiment 1.

Parts (a) to (d) of FIG. 15 are timing charts before and after the turning-off of the power source in the embodiment 1.

Parts (a) and (b) of FIG. 16 are flow charts before and after the turning-off of the power source in the embodiment 1.

FIG. 17 is a block diagram of a printer main body in the embodiment 2.

Parts (a) to (d) of FIG. 18 are timing charts before and after turning-off of the power source in the embodiment 2.

Parts (a) and (b) of FIG. 19 are flow charts before and after the turning-off of the power source in the embodiment 2.

### DESCRIPTION OF THE EMBODIMENTS

In the following, embodiments according to the present disclosure will be described while marking reference to the drawings.

### Embodiment 1

### General Configuration of Image Forming Apparatus

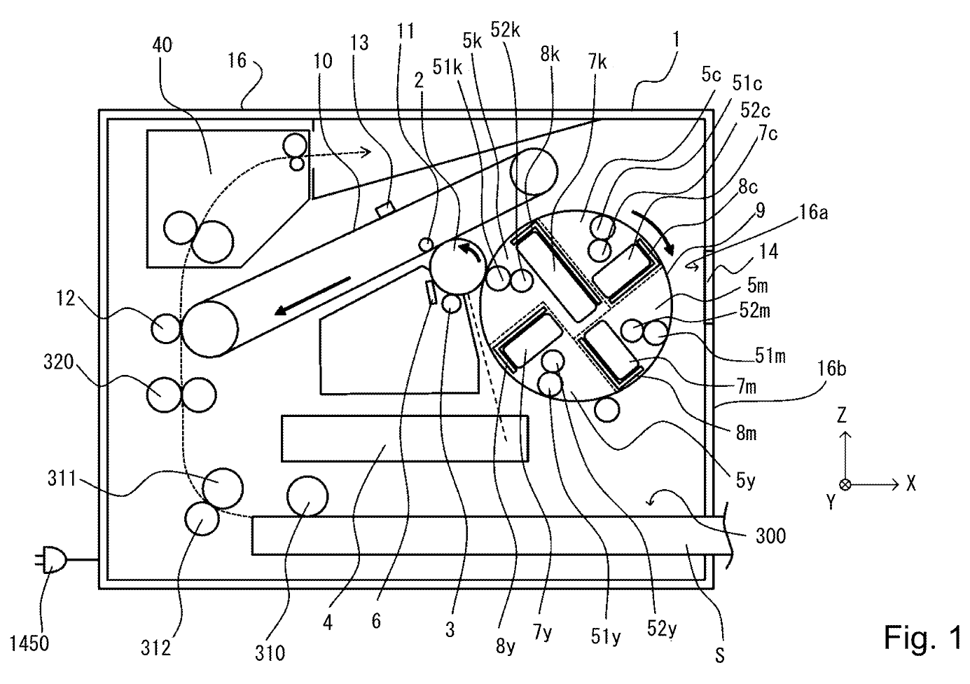

Using FIGS. 1 to 12, an embodiment of an image forming apparatus according to the present disclosure will be described.

In the following description and respective drawings, a vertical direction in the case where the printer main body 1 is installed on a horizontal surface is referred to as a Z direction. A direction which is a direction crossing the Z direction and which extends along a rotational axis of a rotary 9 described later (rotational axis direction of the rotary) is referred to as a Y direction. A direction crossing the Z direction and the Y direction is referred to as an X direction. The X direction and the Y direction may preferably be a horizontal direction. Further, the X direction, the Y direction, and the Z direction may preferably be perpendicular to each other. Further, as desired, directions of arrows X, Y and Z indicated in the respective drawings are represented by +X side, +Y side, and the +Z side, and sides opposite to these directions are represented by -X side, -Y side, and -Z side, respectively. In this embodiment, as an image forming apparatus provided with a plurality of developing units (plurality of developing devices), a color laser beam printer provided with four developing unit is illustrated as an example.

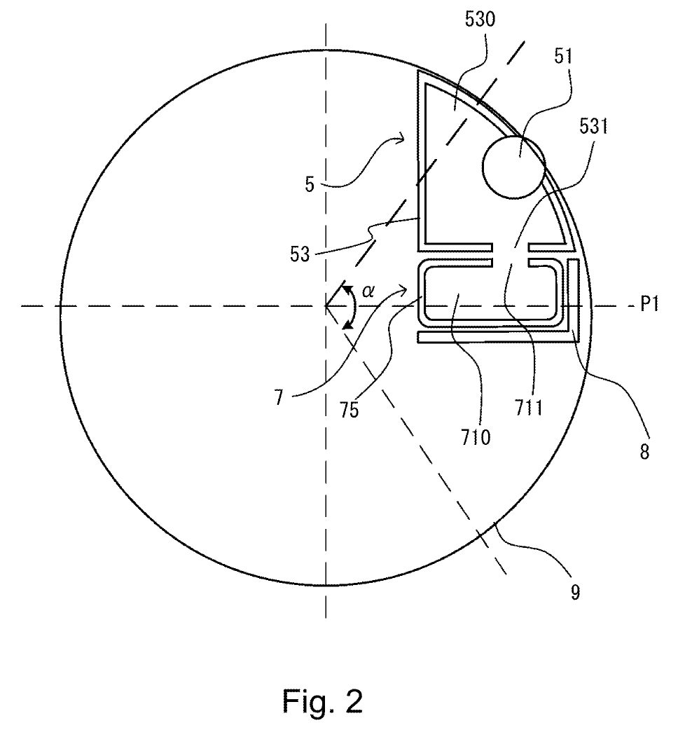

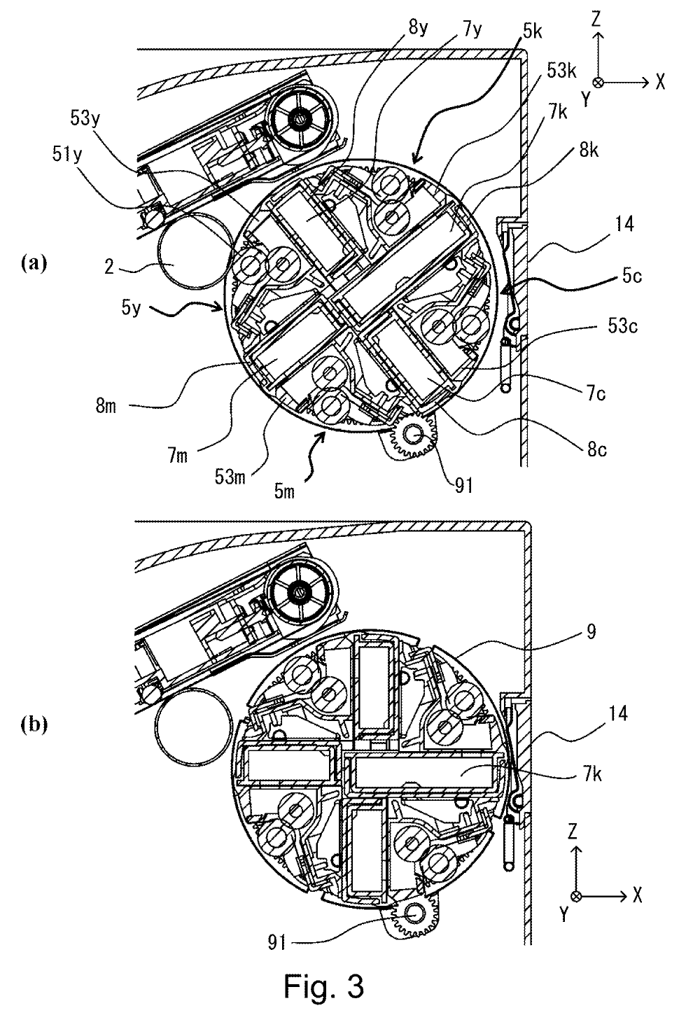

Using FIGS. 1 and 2, a schematic configuration and an image forming operation of the color laser beam printer will be described. FIG. 1 is a schematic sectional view of the color laser beam printer. As shown in FIG. 1, the printer main body 1 accommodates the rotary 9 and includes a frame 16 accommodating the rotary 9. The frame 16 is a casing (framework) of the printer main body 1, formed by a frame or an outer casing member, and has a substantially rectangular parallelopiped shape. The frame 16 is provided with an opening 16a. Specifically, the frame 16 is provided with a side surface 16b extending in a direction crossing the horizontal direction. The side surface 16b forms at least a part of an outer appearance surface of the printer main body 1 on the +X side. The opening 16a is disposed in this side surface 16b. The side surface 16b is a side surface disposed on a side downstream of a discharge opening with respect to a discharging direction in which a sheet S on which an image is formed is discharged through the discharge opening of the printer main body 1. A user is capable of supplying sheets S and acquiring the sheet(s) S by accessing a sheet accommodating portion 300 from a side of the side surface 16b of the printer main body 1. For this reason, the side surface 16b can be said as a front surface of the printer main body 1.

As shown in FIG. 1, the printer main body 1 as the image forming apparatus includes a photosensitive drum 2 as a drum-shaped electrophotographic photosensitive member. At a periphery of the photosensitive drum 2, a charging roller 3, an exposure device 4, four developing units 5y, 5m, 5c, and 5k, and a cleaning unit 6 are provided. Here, symbols "y, m, c, and k" represent colors of yellow, magenta, cyan, and black, respectively. In the following, reference numerals or symbols such as "5y, 5m, 5c, and 5k" are presented as "5y to 5k" in some instances. Further, particularly, in the case where there is no need to specify the colors, the reference numerals or symbols is simply represented by "5" in some instances. The charging roller 3 is a charging means for electrically charging the photosensitive drum 2 uniformly. The exposure device 4 is an exposure means for irradiating the photosensitive drum 2 with laser light depending on image information. The exposure device 4 forms an electrostatic latent image on the photosensitive drum 2 by irradiating the charged photosensitive drum 2 with the laser light. The developing units 5y to 5k are developing means for visualizing the electrostatic latent image formed on the photosensitive drum 2, by developing the electrostatic latent image with toner of corresponding colors. The cleaning unit 6 is a cleaning means for removing toner remaining on the surface of the photosensitive drum 2.

The developing units 5y to 5k include developing rollers 51y to 51k and supplying rollers 52y to 52k. Further, to the developing units 5y to 5k, toner cartridges 7y to 7k are mounted. The toner cartridges 7y, 7m, 7c, and 7k accommodate a yellow toner, a magenta toner, a cyan toner, and a black toner, respectively. That is, the developing units 5y to 5k develop the electrostatic latent image, formed on the photosensitive drum 2, with the yellow toner, the magenta toner, the cyan toner, and the black toner, respectively. Here, the four developing units 5y to 5k are provided in the rotary 9 which is a rotatable rotation supporting member. In addition, the rotary 9 is provided with trays 8y to 8k, and the toner cartridges 7y to 7k are held so as to be detachably mountable to the trays 8y to 8k, respectively. Although as described later, the trays 8y to 8k are supported so as to be slidable and movable to an outside (outer side) of the rotary 9. The trays 8y to 8k (and the toner cartridges 7y to 7k held by the trays 8y to 8k) are slid and moved to the outside of the rotary 9, whereby the toner cartridges 7y to 7k have a configuration in which each of the toner cartridges 7y to 7k is detachably mountable to the rotary 9.

The toner cartridge 7y is an example of a first toner cartridge. The toner cartridge 7c is an example of a second toner cartridge. The toner cartridge 7m is an example of a third toner cartridge. The toner cartridge 7k is an example of a fourth toner cartridge. The developing roller 51y is an example of a first developing roller. The developing roller 51c is an example of a second developing roller. The developing roller 51m is an example of a third developing roller. The developing roller 51k is an example of a fourth developing roller. The developing unit 5y is an example of a first developing device accommodating the toner supplied from the first toner cartridge and including the first developing roller. The developing unit 5c is an example of a second developing device accommodating the toner supplied from the second toner cartridge and including the second developing roller. The developing unit 5m is an example of a third developing device accommodating the toner supplied from the third toner cartridge and including the third developing roller. The developing unit 5k is an example of a fourth developing device accommodating the toner supplied from the fourth toner cartridge and including the fourth developing roller. The rotary 9 is an example of a rotary to which the first to fourth toner cartridges are detachably mountable. The rotary 9 can also be said as an example of a rotary to which the first toner cartridge and the second toner cartridge are detachably mountable. In addition, the rotary 9 is an example of a rotary including the first to fourth developing devices and disposed so that each of the first to fourth developing rollers is rotatable so as to oppose the photosensitive drum 2. The rotary 9 can also be said as an example of a rotary including the first developing device and the second developing device and disposed so that each of the first developing roller and the second developing roller is rotatable so as to oppose the photosensitive drum 2.

Incidentally, in this embodiment, numbering such as a first, second, ... is merely used conveniently for explanation, and can be appropriately replaced in principle.

### Supply of Toner From toner Cartridge to Developing Unit

In the following description, a position where mounting of the toner cartridge 7y to the developing unit 5y through the opening 16a is permitted by rotation of the rotary 9 is referred to as a first exchange position. A position where mounting of the toner cartridge 7c to the developing unit 5c through the opening 16a is permitted by rotation of the rotary 9 is referred to as a second exchange position. In the case where there is no need to particularly distinguish the colors, these positions are referred to as an exchange position P1.

FIG. 2 is a conceptual illustration showing a configuration for supplying the toner from the toner cartridge 7 to the developing unit 5. A toner frame 75 of the toner cartridge 7 is provided with a toner accommodating portion 710 and a discharge opening 711 communicating with the toner accommodating portion 710. A developing frame 53 (53y to 53k) (see part (a) of FIG. 3) of the developing unit 5 is provided with a development-side accommodating portion 530 and a receiving opening 531 communicating with the development-side accommodating portion 530. As described later, in a state in which the toner cartridge 7 is moved to a mounting position, the discharge opening 711 opposes the receiving opening 531. The toner cartridge 7 includes an unshown toner-side sealing member covering the discharge opening 711. Each of the toner-side sealing member and a development-side sealing member is released from sealing thereof, so that each of the discharge opening 711 and the receiving opening 531 is open. In this state, when the rotary 9 is rotated relative to the exchange position P1 of the toner cartridge 7 by an angle larger than an angle α (predetermined angle) shown in FIG. 2, the toner accommodated in the toner accommodating portion 710 is discharged through the discharge opening 711, and the toner discharged through the discharge opening 711 enters the development-side accommodating portion 530 through the receiving opening 531, so that the toner is started to be supplied from the toner cartridge 7 to the developing unit 5. In a state in which the toner cartridge 7 is not mounted to the developing unit 5, the discharge opening 711 is covered with the toner-side sealing member and the receiving opening 531 is covered with the development-side sealing member so as to suppress discharge of the toner through the discharge opening 711 and the receiving opening 531.

### Image Forming Operation of Image Forming Apparatus

Using FIG. 1, an image forming operation in the embodiment 1 will be described. First, the photosensitive drum 2 is rotated in an arrow direction (counterclockwise direction) of FIG. 1 by being synchronized with rotation of an intermediary transfer belt 10.

Then, a surface of the photosensitive drum 2 is electrically charged uniformly by the charging roller 3. Together with this, laser light irradiation of a yellow image is performed by the exposure device 4, so that an electrostatic latent image for yellow is formed on the photosensitive drum 2.

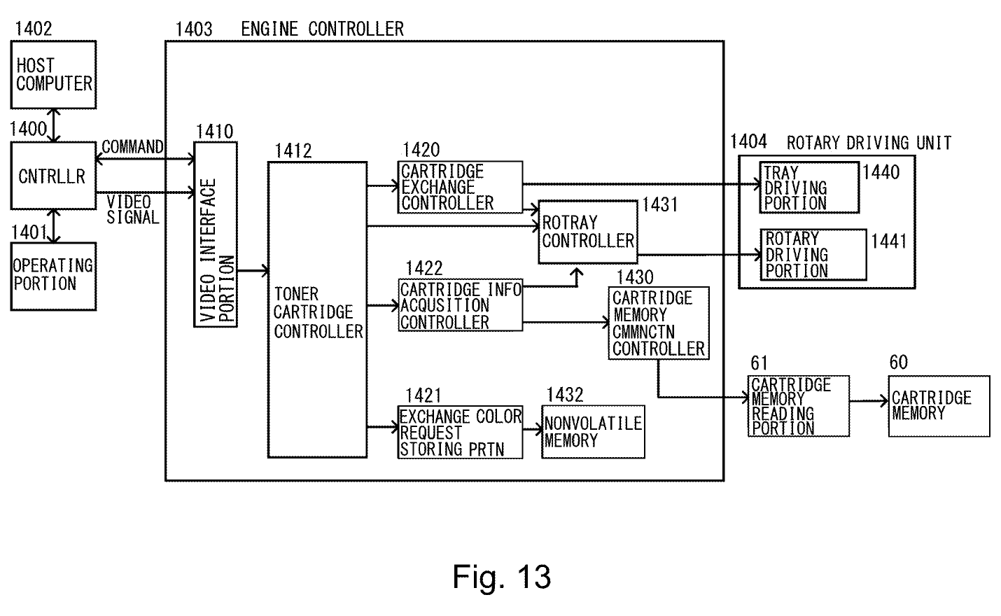

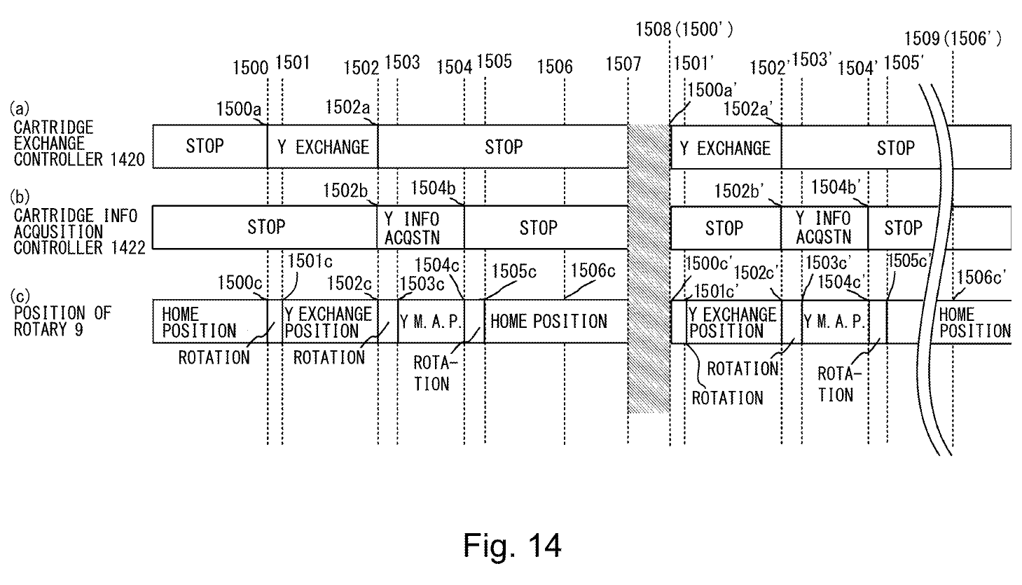

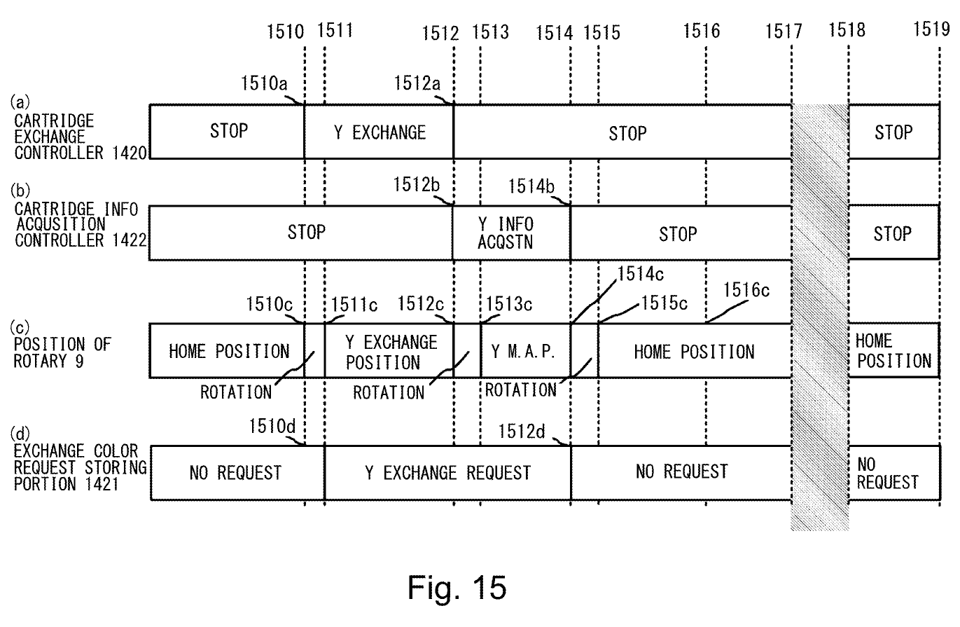

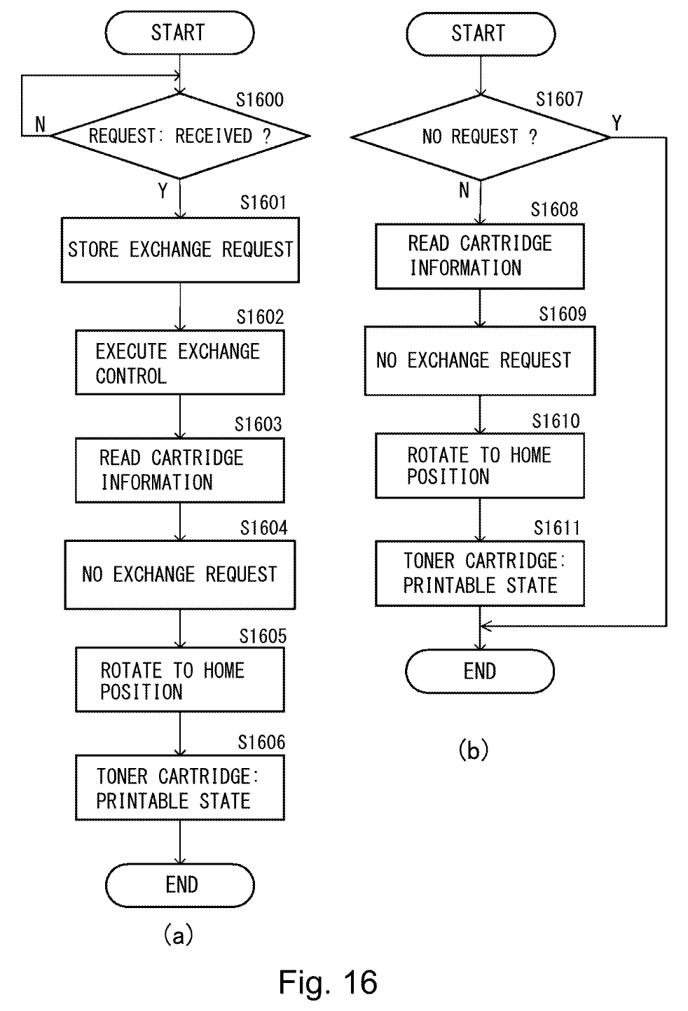

Together with formation of this electrostatic latent image, the rotary 9 is rotated, so that the developing unit 5y for yellow is stopped to a developing position opposing the photosensitive drum 2. Incidentally, the rotary 9 is rotated by a rotary driving portion 1441 (see FIG. 13). In the developing position, the developing roller 51y provided in the developing unit 5y contacts the photosensitive drum 2, so that the electrostatic latent image is developed with the yellow toner. That is, the rotary 9 is rotated in an arrow direction (clockwise direction) of FIG. 1 while supporting the developing units 5y to 5k, whereby the supported four developing units 5y to 5k are successively moved one by one to the developing position opposing the photosensitive drum 2. The developing unit 5 positioned in the developing position develops the electrostatic latent image, formed on the photosensitive drum 2, depending on the color of the toner accommodated thereon. Incidentally, in FIG. 1, the developing roller 51k for black contacts the photosensitive drum 2.

After the electrostatic latent image is developed, the yellow toner formed on the photosensitive drum 2 is transferred (primarily transferred) onto the intermediary transfer belt 10 by a primary transfer roller 11 provided inside the intermediary transfer belt 10. Thus, the primary transfer of the yellow toner image is ended. Then, the developing units 5m, 5c, and 5k for magenta, cyan, and black are successively rotated and moved by rotation of the rotary 9, so that the associated developing unit 5 is stopped in the developing position opposing the photosensitive drum 2. Then, similarly as in the case of the yellow, with respect to each of the colors of the magenta, the cyan, and the black, the formation of the electrostatic latent image, the development of the electrostatic latent image, and the primary transfer of the associated toner image are successively performed. By this, the toner images of the four colors are superposed on the intermediary transfer belt 10. During this period, a secondary transfer roller 12 does not contact the intermediary transfer belt 10. Further, at this time, a cleaning device 13 for removing residual toner on the intermediary transfer belt 10 also does not contact the intermediary transfer belt 10.

On the other hand, the sheets S as a recording material are stacked and accommodated in the sheet accommodating portion 300 provided in a lower portion of the printer main body 1. The sheets S are fed by a pick roller 310. After the sheets S are separated one by one by a feed roller 311 and a separation roller 312, and the separated sheet S is sent to a conveying roller pair 320. The conveying roller pair 320 sends the fed sheet S to a nip (secondary transfer portion) between the intermediary transfer belt 10 and the secondary transfer roller 12. The four-color toner images superposed on the intermediary transfer belt 10 are transferred (secondarily transferred) collectively onto the surface of the conveyed sheet S.

The sheet S on which the toner images are transferred is sent to a fixing device 40. In the fixing device 40, the sheet S is heated and pressed, so that an unfixed toner image is fixed on the sheet S. By this, a color image is formed on the sheet S. Then, this sheet S is discharged from the fixing device 40.

As described above, in the image forming operation in the embodiment 1, an image forming unit including the photosensitive drum 2, the developing roller 51, the intermediary transfer belt 10, and the like, a sheet (paper) feeding/conveying unit including the pick roller 310, the feed roller 311, the conveying roller pair 320, and the like, and the fixing device 40 are rotated by an unshown driving source.

### Rotary Configuration

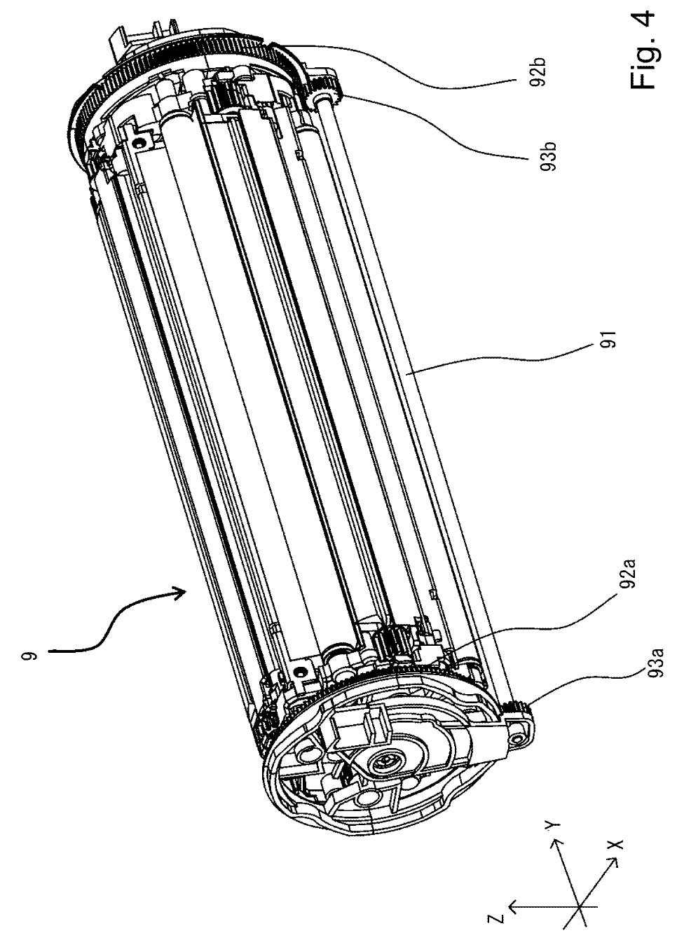

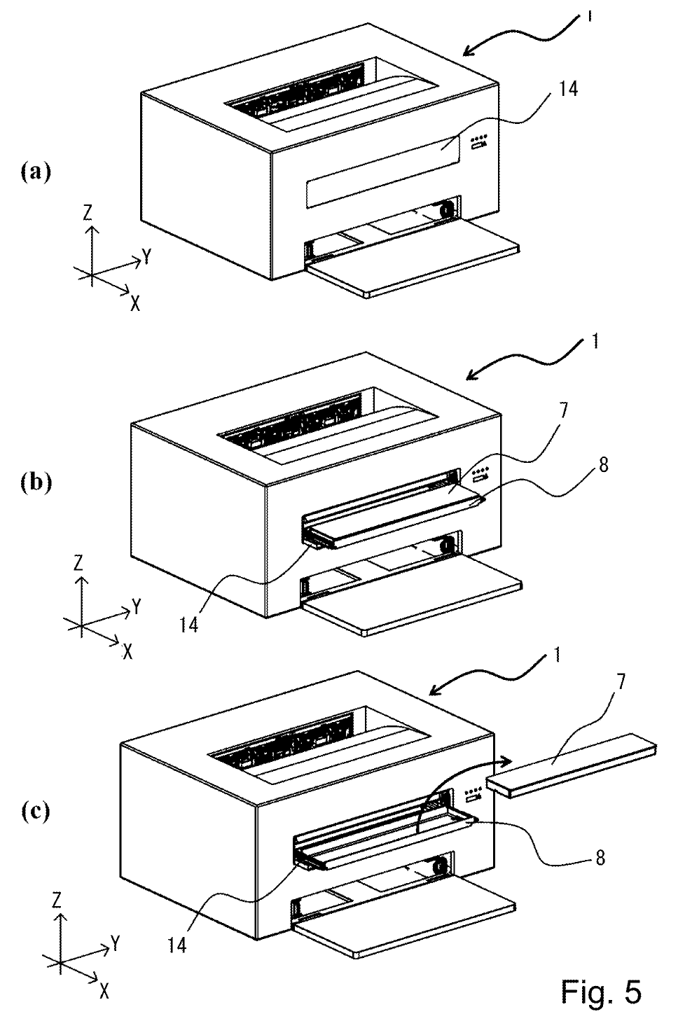

Using FIGS. 3 and 4, a configuration of the rotary 9 will be described. Parts (a) and (b) of FIG. 3 are sectional views of the rotary 9 and a periphery thereof. FIG. 4 is a schematic view of an outer appearance of the rotary 9. As described above, the toner cartridges 7y to 7k are detachably mountable to the rotary 9, and when the toner in each of the toner cartridges 7y to 7k is used up, the user is capable of exchanging the associated one of the toner cartridges 7y to 7k. During exchange of the toner cartridges 7y to 7k, the rotary 9 is stopped in an exchange position.

Part (a) of FIG. 3 shows a cross section of the rotary 9 and the periphery thereof in a state in which the associated developing roller is stopped in the developing position, and as an example, the developing roller 51y for yellow contacts the photosensitive drum 2. Part (b) of FIG. 3 shows a cross section of the rotary 9 and the periphery thereof in a state in which the associated toner cartridge is stopped in an exchange position, and as an example, the toner cartridge 7k for black is stopped in the exchange position. As shown in parts (a) and (b) of FIG. 3, in the rotary 9, the four trays 8y to 8k are disposed, and the toner cartridges 7y to 7k are held by the trays 8y to 8k, respectively. At this time, a state in which the toner cartridges 7y to 7k are mounted to the developing units 5y to 5k, respectively, is formed. In the embodiment 1, the toner cartridge 7k accommodating the black toner is larger in size than each of the toner cartridges 7y, 7m, and 7c accommodating the yellow toner, the magenta toner, and the cyan toner, and is capable of accommodating the toner in a larger amount than each of the toner cartridges 7y, 7m, and 7c. For that reason, the tray 8k holding the toner cartridge 7k for black is larger in size than each of the trays 8y, 8m, and 8k holding the toner cartridge 7y for yellow, the toner cartridge 7m for magenta, and the toner cartridge 7c for cyan, respectively. That is, in the rotary 9, the four toner cartridges 7y to 7k different in size and the four trays 8y to 8k different in size are disposed.

Here, the rotary 9 is supported swingably about a swing shaft 91. In the developing position, the rotary 9 is urged by an unshown urging member, whereby the developing roller 51y contacts the photosensitive drum 2. In a process in which the rotary 9 is rotated in the clockwise direction in part (a) of FIG. 3 and is moved to the exchange position, the rotary 9 is swung about a swing shaft 91 by an unshown separation (spacing) mechanism, so that the developing roller 51y is separated from the photosensitive drum 2. In the exchange position, the toner cartridge 7k is stopped in a position opposing a door 14 provided at the front surface of the printer main body 1 (part (b) of FIG. 3). Further, the developing rollers 51y to 51k are separated from the photosensitive drum 2. In this state, the tray 8k is slid and moved from a mounting position of the developing unit 5k to an outside of the rotary 9, so that the user is capable of exchanging the toner cartridge 7k.

Incidentally, in this embodiment, the developing position for the developing unit 5y and the exchange position for the toner cartridge 7k were described, but the same applied to the developing position for the developing units 5m, 5c, and 5k and the exchange position for the toner cartridges 7y, 7m, and 7c. Incidentally, an exchange (exchanging) operation of the toner cartridges 7y to 7k will be described later.

Using FIG. 4, rotational drive of the rotary 9 will be described. As shown in FIG. 4, disk gears 92a and 92b are formed in opposite end portions of the rotary 9 with respect to a longitudinal direction of the rotary 9. Further, the opposite end portions of the swing shaft 91 with respect to a longitudinal direction of the swing shaft 91, driving gears 93a and 93b are connected so as to be capable of being drive-transmitted. Here, a driving force of the rotary driving portion 1441 (first driving source) is transmitted to the driving gear 93b, and is transmitted to the disk gears 92a and 92b by the driving gears 93a and 93b, whereby the rotary 9 is rotated.

### Exchange Operation of Toner Cartridge

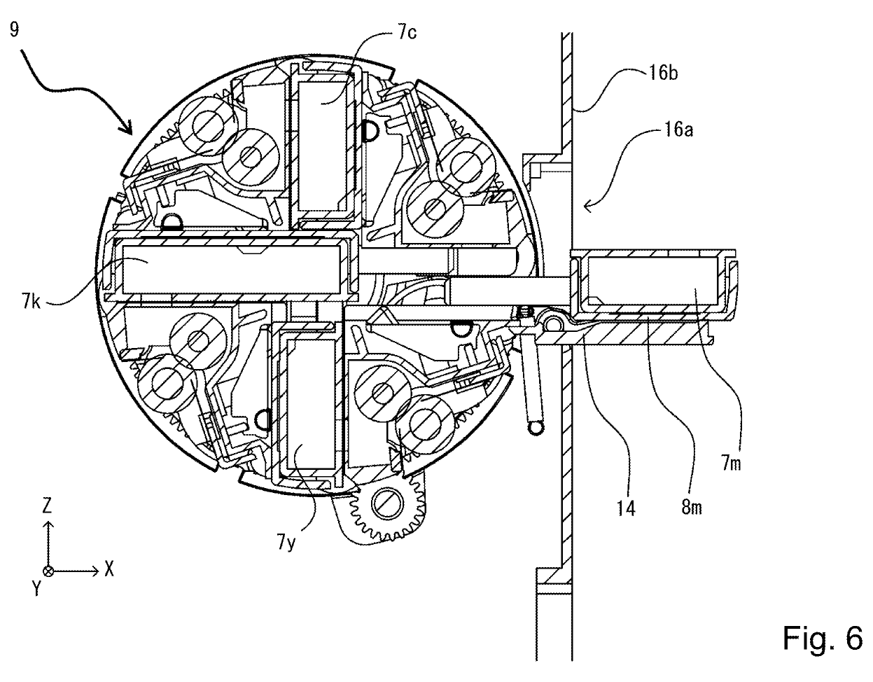

The exchange operation of the toner cartridges 7y to 7k will be described by using FIGS. 5 and 6.

Parts (a) to (c) of FIG. 5 are schematic views of an outer appearance of the printer main body 1. FIG. 6 is a sectional view of the rotary 9 and a periphery thereof.

Part (a) of FIG. 5 shows the outer appearance of the printer main body 1 during the image forming operation and, in a stand-by state. At this time, the door 14 is in a closed state. Part (b) of FIG. 5 shows the outer appearance of the printer main body 1 during exchange of the toner cartridges 7y to 7k. At this time, the door 14 is in an open state, and the tray 8 and the toner cartridge 7 are moved to the outside of the printer main body 1.

The exchange operation of the toner cartridges 7y to 7k will be described. First, when the user provides an instruction of an associated one of the toner cartridges 7y to 7k to the printer main body 1, the rotary 9 is rotated to the exchange position of the associated toner cartridge 7 to be exchanged (toner cartridge 7 in which the toner is used up) and is stopped at the exchange position. Here, "the user provides an instruction" means that the user performs an operation such that the user pushes an exchange button provided to the printer main body 1, for example.

Next, the tray 8 and the toner cartridge 7 are slid and moved from the mounting position to the developing unit 5 to the outside of the printer main body 1 by a tray driving portion 1440 (see FIG. 13). At this time, the door 14 is rotatably supported relative to the printer main body 1, and the door 14 is put in the open state by slide-movement of the tray 8 (state of part (b) of FIG. 5). Here, the toner cartridge 7 is held by the tray 8 so as to be detachably mountable to the tray 8, and therefore, as shown in part (c) of FIG. 5, the user is capable of performing the exchange operation by removing (detaching) the toner cartridge 7 from the tray 8 and then by mounting a new toner cartridge 7 to the tray 8. Incidentally, in the case where a plurality of toner cartridges 7 are exchanged, the exchange operation can be performed by repeating the above-described operation.

FIG. 6 shows a cross section of the rotary 9 and the periphery thereof during the exchange of the toner cartridges 7y to 7k, and as an example, the tray 8m and the toner cartridge 7m are slid and moved to the outside of the printer main body 1. As shown in FIG. 6, during the exchange of the toner cartridges 7y to 7k, the user performs a demounting/mounting operation of the toner cartridge 7 from/to the tray 8, and therefore, it is desirable that a whole of the toner cartridge 7 is exposed from the front surface of the printer main body 1.

### Tray Arrangement of Rotary

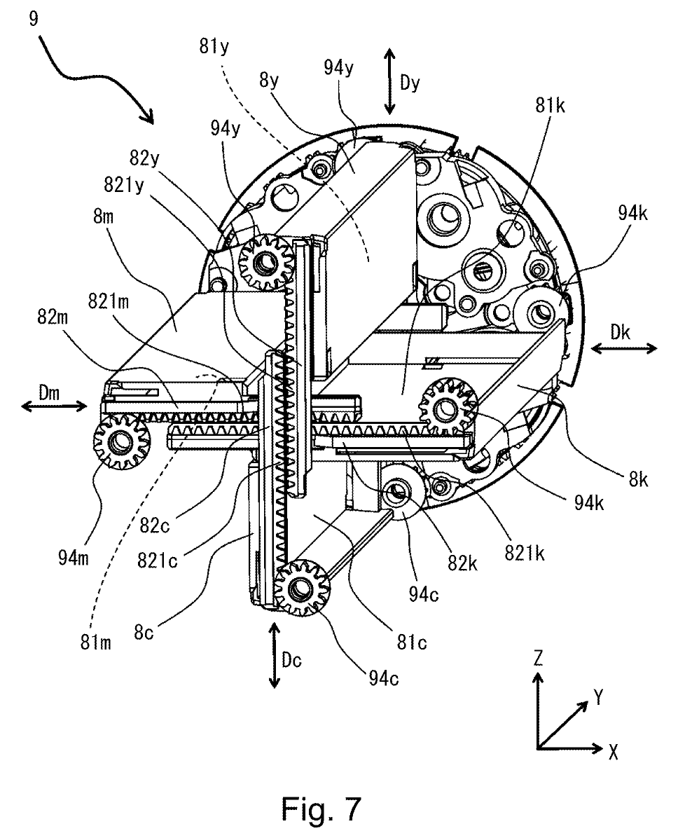

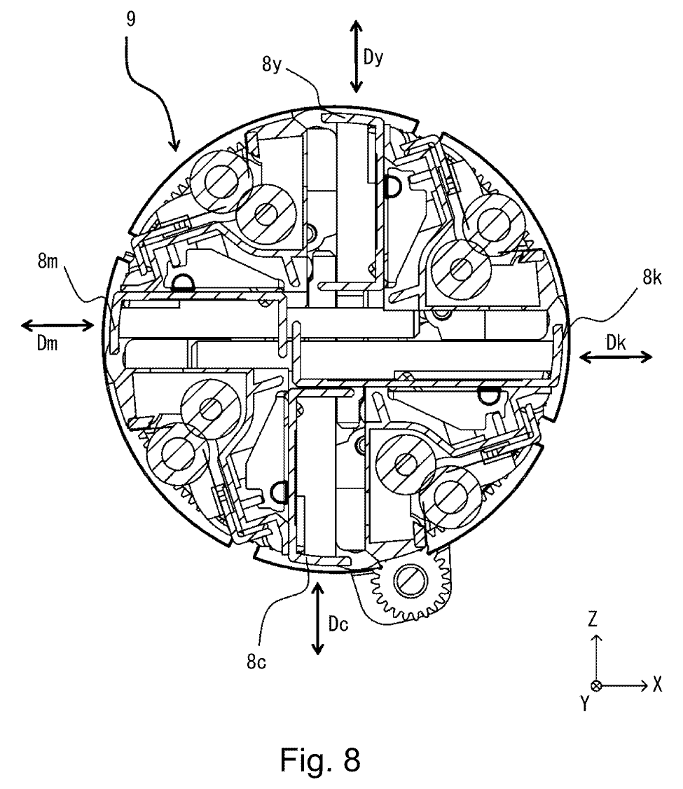

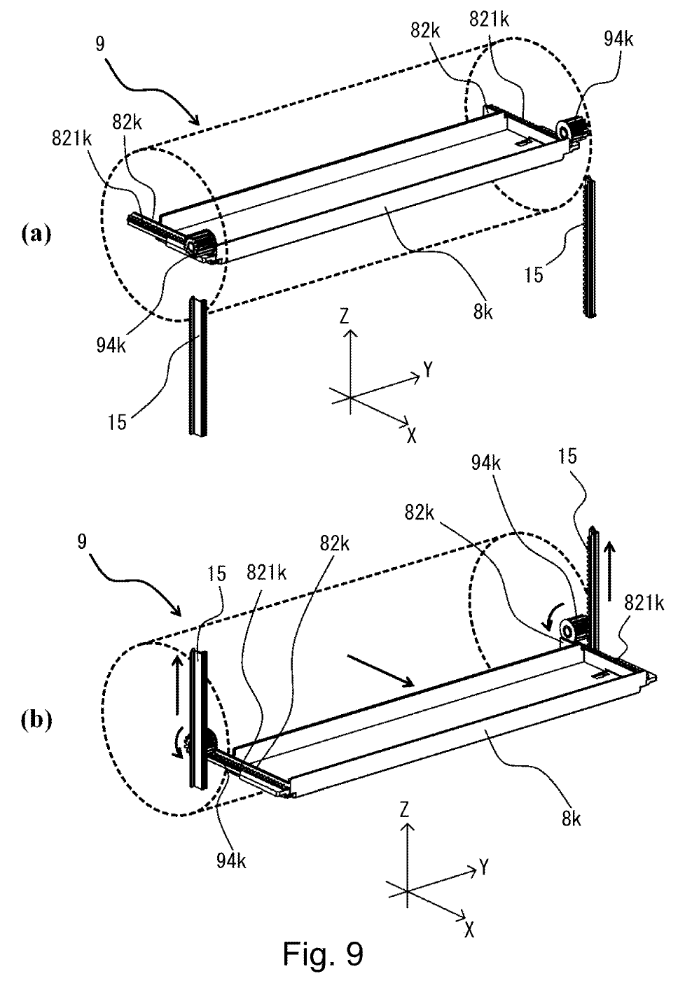

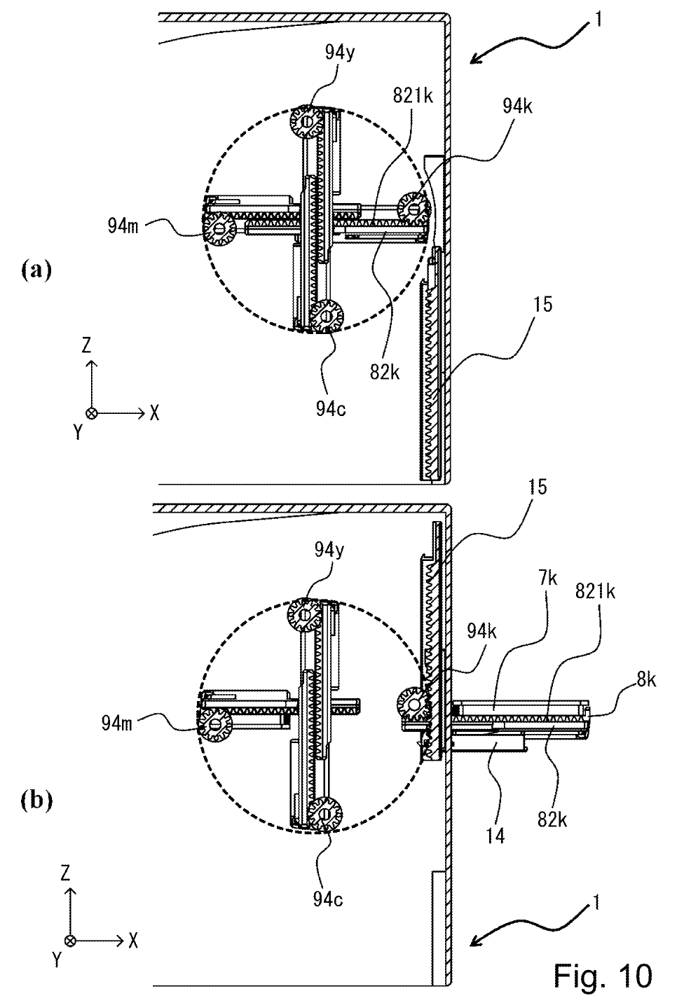

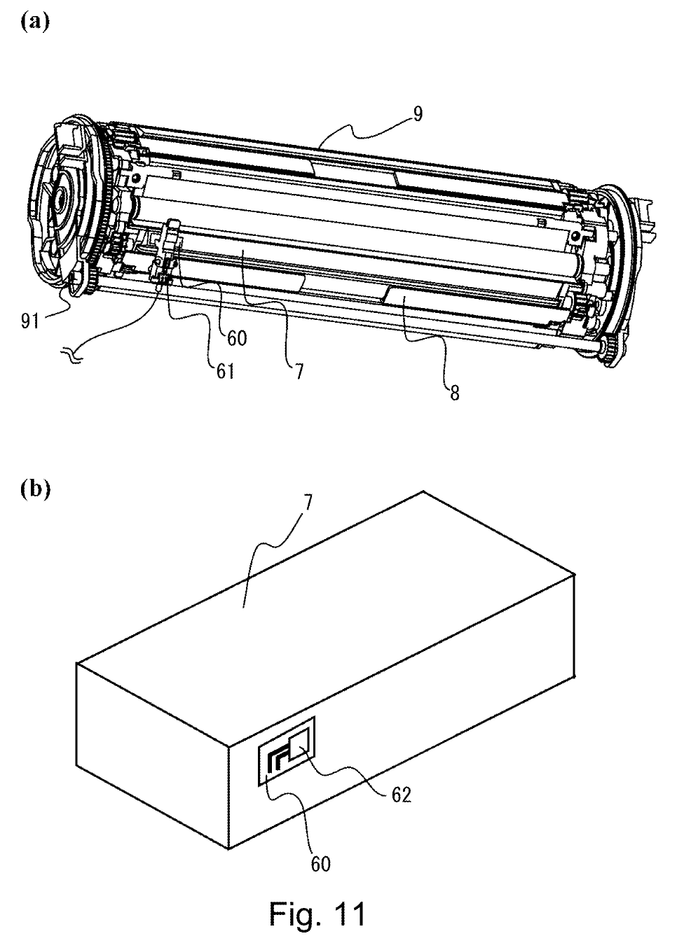

Using FIGS. 7 and 8, an arrangement of the trays 8y to 8k in the rotary 9 will be described. FIG. 7 is a perspective view showing the arrangement of the trays 8y to 8k in the rotary 9. FIG. 8 is a sectional view showing the arrangement of the trays 8y to 8k in the rotary 9.

As shown in FIG. 7, the trays 8y to 8k are provided with holding portions 81y to 81k and tray rails 82y to 82k for the toner cartridges 7y to 7k (not shown in FIG. 7). The tray rails 82y to 82k are provided in each of opposite portions, with respect to the longitudinal direction, sandwiching the holding portions 81y to 81k, therebetween. The tray rails 82y to 82k are provided with rack portions 821y to 821k formed in each of opposite portions with respect to the longitudinal direction. Further, in the rotary 9, rack gears 94y to 94k are rotatably held, so that the rack gears 94y to 94k engage with the rack portions 821y to 821k, respectively, so as to be drive-transmittable.

Further, as shown in FIGS. 7 and 8, in the rotary 9, the four trays 8y to 8k are superposedly arranged. Insertion/extraction directions of the trays 8y to 8k are directions (double-pointed arrow directions in FIGS. 7 and 8) each rotated from an upstream direction with respect to a rotational direction by 90°. For that reason, each of the tray 8y for yellow, the tray 8c for cyan, the tray 8m for magenta, and the tray 8k for black is held slidably and movably in the same direction.

### Drive Configuration of Insertion/Extraction of Tray

Using FIGS. 9 and 10, drive configuration of insertion/extraction of the trays 8y to 8k disposed in the rotary 9 will be described. Parts (a) and (b) of FIG. 9 are perspective views showing the drive configuration of insertion/extraction of the trays 8y to 8k will be described. Parts (a) and (b) of FIG. 10 are sectional views showing the drive configuration of insertion/extraction of the trays 8y to 8k. In the following description, of the four trays 8y to 8k, the tray 8k is described as an example, but the same also applies to the drive configuration of insertion/extraction of each of the trays 8y, 8m, and 8c.

Part (a) of FIG. 9 shows a state in which the tray 8k is disposed inside the rotary 9 (i.e., shows a state in which the toner cartridge 7k is mounted to the developing unit 5k). Part (b) of FIG. 9 shows a state in which the tray 8k is slid and moved to the outside of the rotary 9. As described above, two rack portions 821k are formed in the opposite end portions with respect to the longitudinal direction. Further, the rack gear 94k and a driving rack 15 are also provided in each of positions corresponding to the rack portions 821k of the opposite end portions with respect to the longitudinal direction. The tray 8k is held by the rotary 9 so as to be slidably movable relative to the rotary 9 in a direction parallel to the tray rail 82k. The driving rack 15 is held by the rotary 9 so as to be slidably movable relative to the rotary 9 in a vertical direction (Z direction).

Using parts (a) and (b) of FIG. 10, an insertion/extraction operation of the tray 8k in which the tray 8k is slid and moved from an inside (position where the toner cartridge 7k is mounted to the developing unit 5k) will be described. The insertion/extraction operation is performed by the tray driving portion 1440 (second driving source) (see FIG. 13), the driving rack 15, the rack gear 94k, and the rack portion 821k. First, by the driving force transmitted by the tray driving portion 1440, the driving rack 15 is slid and moved in an upward direction of the printer main body 1, so that the driving force (drive) is transmitted to the rack gear 94k. The rack gear 94k is rotated in the counterclockwise direction, and the drive is transmitted to the rack portion 821k, whereby the tray 8k is slid and moved from the mounting position of the tray 8y to the developing unit 5k to the outside of the rotary 9.

Further, after the exchange of the toner cartridge 7k, an operation for sliding and moving the tray 8k to be inside of the rotary 9 (to a position where the toner cartridge 7k is mounted to the developing unit 5k) can be performed in the following manner. That is, this operation can be performed by rotationally driving the tray driving portion 1440 in a direction opposite to the direction when the tray 8k is slid and moved to the outside of the rotary 9. In this case, the driving rack 15 is slid and moved in a downward direction of the printer main body 1, so that the tray 8k is drawn into the inside of the rotary 9.

As described above, the insertion/extraction operation of the tray 8k disposed inside the rotary 9 can be performed by the tray driving portion 1440. That is, the exchange operation of the toner cartridge 7 can be performed in a state in which electric power is supplied from a power source to the printer main body 1, while the exchange operation of the toner cartridge 7 cannot be performed in a state in which supply of electric power is cut off.

### Cartridge Memory and Cartridge Memory Reading Portion

Parts (a) and (b) of FIG. 11 are perspective views showing a configuration of a cartridge memory 60 (cartridge storing portion) of the toner cartridge 7 and a cartridge memory reading portion 61 (hereinafter, referred to as a reading portion 61) for reading information recorded in the cartridge memory 60. Hereinafter, the cartridge memory 60 is referred to as a memory 60. In addition, when the memory 60 of each of the toner cartridges 7, the memory 60 is represented in the following manner. The memory of the toner cartridge 7y for yellow is represented by the memory 60y, the memory of the toner cartridge 7m for magenta is represented by the memory 60m, the memory of the toner cartridge 7c for cyan is represented by the memory 60c, and the memory of the toner cartridge 7k for black is represented by the memory 60k.

As described above, a cartridge memory communication controller 1430 (see FIG. 13) of an engine controller 1403 accesses the memory 60 through the reading portion 61 and reads information stored in the memory 60. That is, the reading portion 61 electrically connects the memory 60 and the cartridge memory communication controller 1430. In the following description, reading of information stored in the memory 60 through the reading portion 61 by the cartridge memory communication controller 1430 is called as reading of the memory 60 by the reading portion 61 in some instances.

Each of the memory 60 and the reading portion 61 is provided with an electrically connectable contact configuration.

The memory 60 is held on a side surface of the toner cartridge 7 with respect to the longitudinal direction and is disposed in a position where the memory 60 is connectable to the reading portion 61 in a state in which the toner cartridge 7 is accommodated in the rotary 9. The reading portion 61 is retracted to a position where rotation of the rotary 9 is not hindered and is contacted to a contact portion of the memory 60 when information is acquired from the memory 60. A retracting operation and a contact operation of the reading portion 61 are performed by an unshown driving source. In the embodiment 1, a configuration in which the contact of the reading portion 61 is connected to a wiring pattern is employed, but the contact portion may also be configured by using a lead wire or the like. Further, the reading portion 61 is connected to an unshown control substrate.

### Arrangement of Reading Portion and Reading Operation

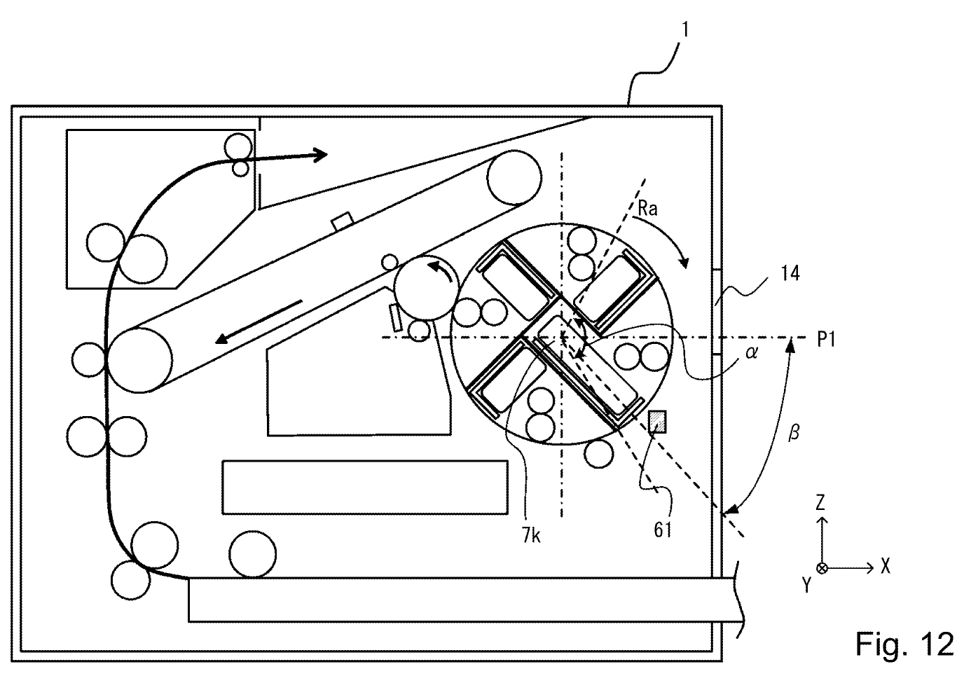

In FIG. 12, an arrangement of the reading portion 61 of the printer main body 1 is shown. As described in FIG. 2, in the case where the rotation angle of the rotary 9 becomes the rotation angle larger than the angle α in FIG. 2, the toner is supplied from the toner cartridge 7 to the developing unit 5. In the embodiment 1, the reading portion 61 is disposed in a position where the rotary 9 is rotated relative to the exchange position P1 of the toner cartridge 7 by an angle β in a rotational direction Ra (clockwise direction). The angle β is an angle within the angle α at which the toner is not supplied from the toner cartridge 7 to the developing unit 5 (angle β) < (angle α/2)). In the following, a position where the rotary 9 is rotated relative to the exchange position P1 by the angle β in the rotational direction Ra (clockwise direction) is represented by a memory access position (reading position) of the toner cartridge 7. Specifically, the memory access position of the toner cartridge 7y is referred to as a Y memory access position, and the memory access position of the toner cartridge 7m is referred to as an M memory access position. Further, the memory access position of the toner cartridge 7c is referred to as a C memory access position. Further, the memory access position of the toner cartridge 7k is referred to as a K memory access position. Each of the memory access positions is an example of a position of the rotary 9 where the reading operation described later is permitted.

Next, the reading operation of the memory 60 through the reading portion will be described. When the toner cartridge 7 is exchanged, the rotary 9 is rotated in the rotational direction Ra (clockwise direction). At this time, the reading portion 61 is retracted from the rotary 9. The rotational direction is the same as the rotational direction during normal image formation. The rotary 9 is stopped in a position, which is a position where the memory 60 and the reading portion 61 oppose each other, and where the rotary 9 is rotated from the exchange position P1 by the angle β. After the rotary 9 is stopped, the reading portion 61 is contacted to the contact portion of the memory 60 and is electrically connected to the memory 60. After reading of information in the memory 60 is made by the reading portion 61, the reading portion 61 is retracted from the memory 60.

Incidentally, the reading portion 61 may also be disposed on a side upstream of the exchange position P1 with respect to the rotational direction Ra. In this case, when the toner cartridge 7 is exchanged, the rotary 9 is rotated in a direction opposite to the rotational direction Ra. Also, in this case, after the reading of the information in the memory 60 through the reading portion 61 is made, supply of the toner from the toner cartridge 7 to the developing unit 5 is started.

In this embodiment, the engine controller 1403 takes the printable state in the case where reading of pieces of information of the memories of all the toner cartridges 7 is completed. Incidentally, a state in which the reading of the information of the memory 60 of the toner cartridge 7 is completed can also be called as a printable state for the associated cartridge 7.

Here, in the printable state, the rotary 9 is at rest. In the printable state, in the case where the engine controller 1403 receives an image formation start signal, the image forming operation is started. In the printable state, either one of the developing rollers 51 opposes the photosensitive drum 2. In the printable state, the rotary 9 may also take the developing position (see part (a) of FIG. 3). In the printable state, the rotary 9 is in a position different from the exchange position. That is, with respect to the rotational direction of the rotary 9, a position of each of the toner cartridges 7 and a position of the opening 16a are different from each other. In the printable state, it can also be said that removal of the toner cartridge 7 from the rotary 9 is restricted.

### Summary of Embodient 1

Characteristic configuration and control in the embodiment 1 will be described. In the embodiment 1, control for determining whether or not a reading operation of an image forming condition from the memory 60 of the toner cartridge 7 is to be executed when the printer main body 1 is actuated from a power source off (OFF) state to the printable state (preparation state) will be described. In other words, control in which whether or not the reading operation of the memory 60 is needed when the power source of the printer main body 1 is turned on from the turned-off state is determined will be described.

In the case where the exchange of the toner cartridge 7 is made in a state in which the electric power is not supplied to the printer main body 1, the engine controller 1403 of the printer main body 1 cannot detect whether or not the toner cartridge 7 is exchanged. That is, at a point of time when the power source of the printer main body 1 is turned on from the turned-off state, the engine controller 1403 cannot determine whether or not the toner cartridge 7 is the same as the toner cartridge 7 before the power source of the printer main body 1 is turned off. Accordingly, in the case where the exchange operation of the toner cartridge 7 is enabled in a state in which the electric power is not supplied to the printer main body 1, it is preferable that the reading operation of the memory 60 is always performed when the power source of the printer main body 1 is turned on from the turned-off state.

On the other hand, as described above, according to this embodiment, the exchange operation of the toner cartridge 7 can be performed in a state in which the electric power is supplied to the printer main body 1, while the exchange operation of the toner cartridge 7 cannot be performed in a state in which the electric power is not supplied to the printer main body 1. Accordingly, at least in a state in which the printer main body 1 is normally used, the toner cartridge 7 is the same in principle between before the power source of the printer main body 1 is turned off and after the power source of the printer main body 1 is turned on. That is, when the power source of the printer main body 1 is turned on from the turning-off state (when the printer main body 1 is actuated), there is no need to perform the reading operation of the memory 60.

In this embodiment, the engine controller 1403 takes the printable state in the case were reading of pieces of information of the memories 60 of all the toner cartridges 7 is completed. Specifically, in the case where the toner cartridge 7 is exchanged, the engine controller 1403 takes the printable state after the reading operation of the memory 60 of at least the toner cartridge 7 which was exchanged. In addition, the engine controller 1403 may also take the printable state after the reading operation of the memories 60 of the exchanged toner cartridge 7 and the toner cartridges 7 other than the exchanged toner cartridge 7.

Further, in the case where the supply of the electric power to the printer main body 1 in the printable state is finished, and thereafter the electric power is supplied to the printer main body 1 and thus the printer main body 1 is actuated, the engine controller 1403 takes the printable state without performing the reading operation of the memory 60.

### Block Diagram in Embodiment 1

FIG. 13 is a block diagram of the printer main body 1 of the embodiment 1. A controller 1400 is capable of communicating with each of an operating portion 1401, a host computer 1402, and the engine controller 1403. Incidentally, a function of the engine controller 1403 is realized by one or more CPUs.

### Exchange of Toner Cartridge

Control of the printer main body 1 for the user to exchange the toner cartridge 7 will be described. When the controller 1400 receives an exchange request of the toner cartridge 7 from the operating portion 1401 or the host computer 1402, the controller 1400 provides an instruction of exchange of the toner cartridge 7 to the engine controller 1403 through a video interface portion 1410. The toner cartridge controller 1412 (controller) of the engine controller 1403 carries out the following control when receives the exchange instruction of the toner cartridge 7 from the video interface portion 1410. That is, the toner cartridge controller 1412 provides an instruction to an exchange color request storing portion 1421 (storing portion) to store the exchange request of the toner cartridge 7 instructed to be exchanged. The exchange request stored in the exchange color request storing portion 1421 is an example of requested information.

The toner cartridge controller 1412 provide an instruction to a toner cartridge exchange controller 1420 to exchange the toner cartridge 7 instructed to be exchanged (hereinafter, this controller is referred to as an exchange controller 1420). The exchange color request storing portion 1421 stores information to be stored, in a non-volatile memory 1432 (main body storing portion). Further, the exchange color request storing portion 1421 causes the memory 60 of the exchange-requested toner cartridge 7 to store whether or not the reading operation is completed, in other words, information as to whether or not the reading operation is needed. In the embodiment 1, necessary/unnecessary information of the reading operation is also used by the above-described exchange request. However, the information may also be stored in the non-volatile memory 1432 by using a flag other than the exchange request. The non-volatile memory 1432 is a storing device capable of holding the stored information even when the supply of the electric power to the printer main body 1 is stopped.

When the exchange instruction of the toner cartridge 7 is provided from the toner cartridge controller 1412, the exchange controller 1420 provides an instruction to a rotary controller 1431 to move the rotary 9 to the exchange position of the exchange-instructed toner cartridge 7. When an instruction to rotate the position of the rotary 9 to the exchange position of the toner cartridge 7 is provided to the rotary controller 1431, the rotary controller 1431 causes a rotary driving portion 1441 of the rotary driving unit 1404 (driving device) to be driven, so that the rotary 9 is rotated. The rotary driving portion 1441 is an example of a driving portion for rotating the rotary 9.

The exchange controller 1420 causes the tray driving portion 1440 to be driven when the rotary 9 is moved to the exchange position of the toner cartridge 7, so that the tray 8 is slid to a position where the user is capable of exchanging the toner cartridge 7. When the printer main body 1 moves the tray 8 to the exchange position, the user exchanges the toner cartridge 7.

Thereafter, completion of the exchange of the toner cartridge 7 is instructed to the printer main body 1 by the user through the operating portion 1401 or the host computer 1402. When the controller 1400 receives from the operating portion 1401 or the host computer 1402 that the exchange of the toner cartridge is completed, the exchange completion of the toner cartridge 7 is instructed to the engine controller 1403 through the video interface portion 1410 by the controller 1400. When the toner cartridge controller 1412 receives the exchange completion of the toner cartridge 7 through the video interface portion 1410, the exchange completion of the toner cartridge 7 is instructed to the exchange controller 1420 by the toner cartridge controller 1412. When the exchange controller 1420 receives that the exchange of the toner cartridge 7 is completed, the exchange controller 1420 causes the tray driving portion 1440 to be driven, so that the tray 8 is slid to the inside of the rotary 9.

### After Exchange of Toner Cartridge-Reading Operation

Control of the printer main body 1 after the exchange of the toner cartridge 7 will be described. The toner cartridge controller 1412 provides an instruction to a cartridge information acquisition controller 1422 (hereinafter, referred to as an information acquisition controller 1422) to acquire cartridge information stored in the memory 60 when the toner cartridge 7 is exchanged. Here, in the cartridge information, a kind of the cartridge and a control parameter are included. The kind of the cartridge is, for example, information or the like such as a color of the toner or a cartridge ID. The control parameter is, for example, information or the like, such as a parameter used for control of transfer or fixing described above.

In the case where the position of the rotary 9 is not the memory access position, the information acquisition controller 1422 causes the rotary controller 1431 to drive the rotary driving portion 1441 and provides an instruction to rotate the position of the rotary 9 to the memory access position of the toner cartridge 7. When the position of the rotary 9 becomes the memory access position of the toner cartridge 7, the information acquisition controller 1422 causes the cartridge memory communication controller 1430 (hereinafter, referred to as a memory communication controller 1430) to access the memory 60. The memory communication controller 1430 causes the reading portion 61 to read the information stored in the memory 60. Incidentally, the operation of the reading portion 61 is as described with reference to part (a) of FIG. 11.

Thereafter, when reading of the image forming condition from the memory 60 by the reading portion 61 is completed, the toner cartridge controller 1412 causes the exchange color request storing portion 1421 to clear the exchange request stored in the non-volatile memory 1432. The clearance of the exchange request means that an operation up to the reading operation is completed and means that a subsequent reading operation is not needed.

The toner cartridge controller 1412 does not perform the reading operation in response to the clearance of the exchange request. The toner cartridge controller 1412 completes the preparation of the toner cartridge 7 after the toner cartridge controller 1412 meets all the toner cartridge exchange requests from the user.

As described above, in the case where a state of the request information is a first state, the toner cartridge controller 1412 executes the reading operation and then takes a preparation state (ready) in which the image forming operation is capable of being executed. On the other hand, in the case where the state of the request information is a second state, the toner cartridge controller 1412 takes the preparation state without executing the reading operation. The first state is a state in which execution of the reading operation is needed and in which the exchange request is stored in the above-described embodiment. The second state is a state in which the execution of the reading operation is not needed and in which the exchange request is cleared in the above-described embodiment. In the case where the power source of the printer main body 1 is turned off and in the case where the power source of the printer main body 1 is turned on from the turned-off state, the state of the request information is held in the non-volatile memory 1432. The toner cartridge controller 1412 is an example of a controller configured to control the driving device and to determine whether or not the reading operation is executed, on the basis of the request information.

### Description of Timing Chart in Embodiment 1

Timing charts in the embodiment 1 are shown in FIGS. 14 and 15. FIG. 14 is a timing chart of processing performed in a period until the state of the toner cartridge 7 is put in the printable state in the case where the reading operation is needed after the actuation of the power source of the printer main body 1. FIG. 15 is the timing chart of processing performed in a period until the state of the toner cartridge 7 is put in the printable state in the case where the reading operation is not needed after the actuation of the power source of the printer main body 1. In the timing charts of FIGS. 14 and 15, as an example, an operation after the power source of the printer main body 1 turned off after completion of the exchange of the toner cartridge 7y for yellow will be described. In each of FIGS. 14 and 15, part (a) shows the state of the exchange controller 1420, part (b) shows the state of the information acquisition controller 1422, and part (c) shows the position of the rotary 9, and in FIG. 15, part (d) shows the request stored by the exchange color request storing portion 1421. Incidentally, 1500 to 1509, and 1510 to 1519 represent respective timings. Further, the exchange controller 1420, the information acquisition controller 1422, the rotary 9, and the exchange color request storing portion 1421 are started from "during stop", "during stop", "home position", and "no request", respectively.

### Case Where Reading Operation is Needed During Turning-On of Power Source

First, FIG. 14 will be described. When the toner cartridge controller 1412 receives a toner cartridge exchange instruction for yellow through the video interface portion 1410, the toner cartridge controller 1412 provides an instruction to the exchange controller 1420 to exchange the toner cartridge for yellow (1500a). When the exchange of the toner cartridge for yellow is instructed the exchange controller 1420 is shifted in state from a state of during stop to a state of exchange of the toner cartridge 7y for yellow (hereinafter, this exchange is referred to as "Y exchange"). Incidentally, the case of exchange of the toner cartridge 7m for magenta is referred to as M exchange, the case of exchange of the toner cartridge 7c for cyan is referred to as C exchange, and the case of exchange of the toner cartridge 7k for black is referred to as K exchange.

The exchange controller 1420 provides an instruction to the rotary controller 1431 to rotate the position of the rotary 9 to the exchange position of the toner cartridge 7y for yellow (hereinafter this exchange position is referred to as "Y exchange position") (1500c). The rotary 9 is during rotation in a period from 1500c to 1501c described later. Incidentally, the exchange position of the toner cartridge 7m for magenta is referred to as an M exchange position, the exchange position of the toner cartridge 7c for cyan is referred to as a C exchange position, and the exchange position of the toner cartridge 7k for black is referred to as a K exchange position. The home position is a position of the rotary 9 where the printer main body 1 starts printing.

When the rotary position becomes the Y exchange position (1501c), the exchange controller 1420 causes the driving portion to slide the tray 8y to a position where the user is capable of exchanging the toner cartridge 7y for yellow. When the user exchanges the toner cartridge 7y for yellow, the exchange controller 1420 causes the driving portion to slide the tray 8y to the inside of the rotary 9, so that the state of the rotary 9 is shifted from the Y exchange state to the state during stop (1502a).

When the toner cartridge 7y for yellow is exchanged, the toner cartridge controller 1412 provides an instruction to the information acquisition controller 1422 to acquire cartridge information of the exchanged toner cartridge 7y for yellow (1502b). When the cartridge information acquisition of the toner cartridge 7y for yellow is instructed from the toner cartridge controller 1412, the information acquisition controller 1422 shifts in state from the state during stop to a state during information acquisition of the toner cartridge 7y for yellow. In the following, during information acquisition of the toner cartridge 7y for yellow is referred to as during Y information acquisition. Incidentally, during information acquisition of the toner cartridge 7m for magenta is referred to as a during M information acquisition, during information acquisition of the toner cartridge 7c for cyan is referred to as during C information acquisition, and during acquisition of the toner cartridge 7k for black is referred to as during K information acquisition. The information acquisition controller 1422 provides an instruction to the rotary controller 1431 to rotate the position of the rotary 9 to the memory access position (1502c). The state of the rotary 9 is during rotation in a period from 1502c to 1503c described later.

When the position of the rotary 9 becomes the memory access position (1503c), the information acquisition controller 1422 causes the memory communication controller 1430 to access the memory 60. When the information acquisition controller 1422 acquires the cartridge information (1504b), the state of the information acquisition controller 1422 is shifted from the state of during Y information acquisition to the state during stop. When the information acquisition controller 1422 acquires the cartridge information, the toner cartridge controller 1412 provides an instruction to the rotary controller 1431 to rotate the position of the rotary 9 to the home position (1504c). The state of the rotary 9 is during rotation in a period from 1504c to 1505c described later.

When the position of the rotary 9 is changed from the memory access position to the home position (1505c), the toner cartridge controller 1412 ends the exchange of the toner cartridge 7y and puts the state of the toner cartridge 7y in the printable state (1506c). Thereafter, when an inlet plug 1450 is removed by the user or a power failure occurs, the power source supplying the electric power to the printer main body 1 is turned off (hereinafter, this state is referred to as "power source: OFF") (1507). When the state of the printer main body 1 is restored (power source: ON) from the state of the power source: OFF by insertion of the inlet plug 1450 or restoration from the state of the power failure, the printer main body 1 performs preparation for being put in the printable state (1508). A period from 1507 to 1508 is a period in which the electric power is not supplied from the power source to the printer main body 1. Incidentally, the printer main body 1 may also be switched between power source: OFF and power source: ON by an operating portion such as a power source button.

In the timing chart of FIG. 14, the printer main body 1 starts control for acquiring pieces of cartridge information of all the toner cartridges 7 when the printer main body 1 is returned from the power source: OFF.

In the timing chart of FIG. 14, an operation when the printer main body 1 is returned from the power source: OFF is similar to the operation executed at 1500 and later, and is shown as 1500' to 1506'. Also, for the toner cartridge 7m for magenta, the toner cartridge 7c for cyan, and the toner cartridge 7k for black, an operation which is the same as the operation for the toner cartridge 7y is performed. By this, the pieces of cartridge information of all the toner cartridge 7 stored in the memory 60 are acquired, so that the toner cartridges 7 are put in the printable state (1509).

### Case Where Reading Operation is Not Needed During Turning-On of Power Source

Next, FIG. 15 will be described. When the toner cartridge controller 1412 receives an exchange instruction of the toner cartridge 7y for yellow through the video interface portion 1410, the toner cartridge controller 1412 provides an instruction to the exchange controller 1420 to exchange the toner cartridge 7y for yellow (1510a). The toner cartridge controller 1412 provides an instruction to the exchange color request storing portion 1421 to store reception of a toner cartridge exchange request for yellow (1510d). When the exchange of the toner cartridge for yellow is instructed the exchange controller 1420 is shifted in state from a state of during stop to a state of toner cartridge exchange for yellow (hereinafter, this exchange is referred to as "Y exchange"). The information stored in the non-volatile memory 1432 is changed from the stop state to a Y exchange request. Incidentally, the case of an exchange request of the toner cartridge 7m for magenta is referred to as an M exchange request, the case of an exchange request of the toner cartridge 7c for cyan is referred to as a C exchange request, and the case of an exchange request of the toner cartridge 7k for black is referred to as a K exchange request. In the embodiment 1, the reading operation is not needed when there is no request, and the reading operation is needed when there is an exchange request.

The exchange controller 1420 provides an instruction to the rotary controller 1431 to rotate the position of the rotary 9 to the Y exchange position (1510c). The rotary 9 is during rotation in a period from 1510c to 1511c described later.

When the rotary position becomes the Y exchange position (1511c), the exchange controller 1420 causes the driving portion to slide the tray 8y to a position where the user is capable of exchanging the toner cartridge 7y for yellow. When the user exchanges the toner cartridge 7y for yellow, the exchange controller 1420 causes the driving portion to slide the tray 8y to the inside of the rotary 9, so that the state of the rotary 9 is shifted from the Y exchange state to the state during stop (1512a). When the toner cartridge 7y for yellow is exchanged, the toner cartridge controller 1412 provides an instruction to the information acquisition controller 1422 to acquire cartridge information of the exchanged toner cartridge 7y for yellow (1512b). When the cartridge information acquisition of the toner cartridge 7y for yellow is instructed from the toner cartridge controller 1412, the information acquisition controller 1422 shifts in state from the state during stop to a state during Y information acquisition of the toner cartridge 7y for yellow. The information acquisition controller 1422 provides an instruction to the rotary controller 1431 to rotate the position of the rotary 9 to the Y memory access position (1512c). The state of the rotary 9 is during rotation in a period from 1512c to 1513c described later.

When the position of the rotary becomes the Y memory access position (1513c), the information acquisition controller 1422 causes the memory communication controller 1430 to access the memory 60. When the information acquisition controller 1422 acquires the cartridge information (1514b), the state of the information acquisition controller 1422 is shifted from the state of during Y information acquisition to the state during stop. Further, the information acquisition controller 1422 changes the Y exchange request, stored in the exchange color request storing portion 1421, to no request (1512d).

When the information acquisition controller 1422 acquires the cartridge information, the toner cartridge controller 1412 provides an instruction to the rotary controller 1431 to rotate the position of the rotary 9 to the home position (1514c). The state of the rotary 9 is during rotation in a period from 1514c to 1515c described later. When the position of the rotary 9 is changed from the memory access position to the home position (1515c), the toner cartridge controller 1412 ends the exchange of the toner cartridge 7y and puts the state of the toner cartridge 7y in the printable state (1516c).

Thereafter, when an inlet plug 1450 is removed by the user or a power failure occurs, the state of the power source becomes the power source: OFF (1517). When the printer main body 1 becomes capable of being restored from the state of the power source: OFF by insertion of the inlet plug 1450 or restoration from the state of the power failure, the printer main body 1 performs preparation for being put in the printable state (1518). In the case where the exchange color request stored in the non-volatile memory 1432 is no request, the printer main body 1 is not required to perform the reading operation, and the toner cartridge 7 is put in the printable state (1519). In the case where the exchange color request stored in the non-volatile memory 1432 is the Y exchange request, the toner cartridge controller 1412 determines that acquisition (reading operation) of the toner cartridge information for yellow is needed, and exchanges processing similar to processing from 1512 to 1515.

### Description of Flowchart of Embodiment 1

Parts (a) and (b) of FIG. 16 are flowcharts of the embodiment 1. First, part (a) of FIG. 16 will be described. Part (a) of FIG. 16 is a processing flowchart during the toner cartridge exchange.

### Processing During Cartridge Exchange

In a step (hereinafter, referred to as "S") 1600, the toner cartridge controller 1412 determines whether or not the toner cartridge exchange request is received. In the case where the toner cartridge controller 1412 determined in S1600 that the toner cartridge exchange request is not received, the processing is returned to S1600, and in the case where the toner cartridge controller 1412 determined that the toner cartridge exchange request is received, the processing is caused to go to S1601.

In S1601, the toner cartridge controller 1412 provides an instruction to the exchange color request storing portion 1421 to store the exchange request of the exchange-requested toner cartridge 7. The exchange color request storing portion 1421 causes the non-volatile memory 1432 to store the exchange request (in other words, information that the reading operation is needed). In S1602, the toner cartridge controller 1412 instructs exchange of the toner cartridge 7 for the color received by the exchange request. By this, in order to exchange the toner cartridge 7, the exchange controller 1420 causes the driving portion to rotate the position of the rotary 9 to the exchange position of the toner cartridge 7 and to slide the tray 8 to a position where the user is capable of exchanging the toner cartridge 7. When the user exchanges the toner cartridge 7, the exchange controller 1420 causes the driving portion to slide the tray 8 to the inside of the rotary 9.

In S1603, the toner cartridge controller 1412 causes the driving portion to rotate the rotary 9 so that the position of the rotary 9 becomes the memory access position, and causes the information acquisition controller 1422 to read the cartridge information of the exchanged toner cartridge 7. In S1604, the toner cartridge controller 1412 causes the exchange color request storing portion 1421 to change the exchange request of the exchanged toner cartridge 7 to no request. In S1605, the toner cartridge controller 1412 causes the driving portion to rotate the position of the rotary 9 to the home position. In S1606, the toner cartridge controller 1412 puts the toner cartridge 7 in the printable state, and then ends the processing.

### Processing During Restoration from Power Source: OFF

Next, part (b) of FIG. 16 will be described. Part (b) of FIG. 16 is the flowchart for putting the toner cartridge 7 in the printable state when the printer main body 1 is actuated from the state of power source: OFF.

In S1607, the toner cartridge controller 1412 checks the toner cartridge exchange request stored in the non-volatile memory 1432 by the exchange color request storing portion 1421. Specifically, the toner cartridge controller 1412 determines whether or not the exchange request acquired from the non-volatile memory 1432 is no request (absence of request). In the case where the toner cartridge controller 1412 determined in S1607 that the acquired information is no request, i.e., that the reading operation is not needed, the toner cartridge controller 1412 regards the toner cartridge 7 as has already been put in the printable state and ends the processing.

In the case where the toner cartridge controller 1412 determined in S 1607 that the acquired information is presence of request, the toner cartridge controller 1412 causes the processing to go to S1608. In this case, the reading operation is needed, i.e., there is a need to read the toner cartridge information for the color of the toner cartridge of which exchange is requested (hereinafter, this color is referred to as a requested color). Incidentally, processing of S1608 to S1611 is the same as the processing of S1603 to S1606, respectively, described with reference to part (a) of FIG. 16, and therefore, will be omitted.

As described above, in the embodiment 1, the printer main body 1 receives the toner cartridge exchange request from the user, and in the case where the toner cartridge information is acquired, whether or not the toner cartridge information acquisition is completed is stored in the non-volatile memory. During the actuation of the printer main body 1, from the information stored in the non-volatile memory, whether or not the acquisition of the toner cartridge information is needed is determined. By this, a time required to acquire the toner cartridge information is minimized, so that it becomes possible to improve usability of the user who intends to perform printing.

Incidentally, in the embodiment 1, although the configuration in which the toner cartridge exchange is instructed from the operating portion 1401 was described, a configuration in which the toner cartridge exchange is instructed from the host computer 1402 or a configuration in which the toner cartridge exchange is toner cartridge exchange is instructed from a portable terminal such as a smartphone via wireless communication may also be employed.

In the embodiment 1, as regards the exchange color request storing portion 1421, description that information on a single color requested from the user is stored was made, but it is possible to store an exchange request for a plurality of colors. In that case, in the flowchart of part (b) of FIG. 16 during the actuation of the printer main body 1, reading of toner cartridge information for the plurality of stored requested colors is made.

In the embodiment 1, the information of the exchange color request storing portion 1421 is made no request at a timing of completion of the toner cartridge information acquisition, but the information of the exchange color request storing portion 1421 may be made no request at a timing when processing such as analysis of the acquired information is ended.

Further, during the exchange of the toner cartridge 7, when the toner cartridge 7 is removed from the tray 8, in the non-volatile memory 1432, information to the effect that "reading operation is performed" may also be stored. Further, the information to the effect that "reading operation is performed" is held from mounting of the toner cartridge 7 on the tray 8 until the reading operation is completed.

As described above, according to the embodiment 1, the time required for the operation performed until the state of the toner cartridge becomes the printable state is reduced, so that the usability can be improved.

### Embodiment 2

In the embodiment 1, in the case where the toner cartridge exchange request from the user is received and the toner cartridge information is acquired, information as the whether or not the toner cartridge information acquisition is completed, in other words, information as the whether or not the reading operation is not needed is stored in the non-volatile memory. During the actuation of the printer main body 1, from the information stored in the non-volatile memory, whether or not the acquisition of the toner cartridge information is needed is determined. By this, a time required for acquiring the toner cartridge information is minimized, so that the usability of the user who intends to perform the printing can be improved. Such an example was described. In an embodiment 2, an example in the case where the printer main body 1 fails to acquire cartridge information of an exchanged toner cartridge will be described. That is, whether or not the reading operation is not needed is determined depending on whether or not a communication state is good. As regards a configuration of the embodiment 2, only a portion thereof different from the configuration described in the embodiment 1 will be described.

### Block Diagram in Embodiment 2

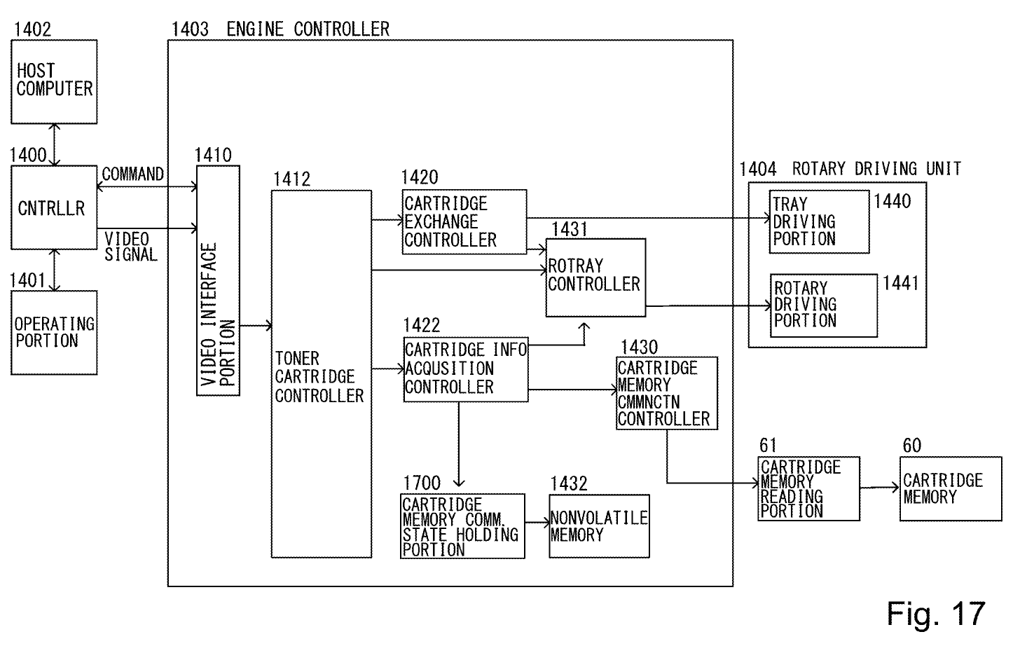

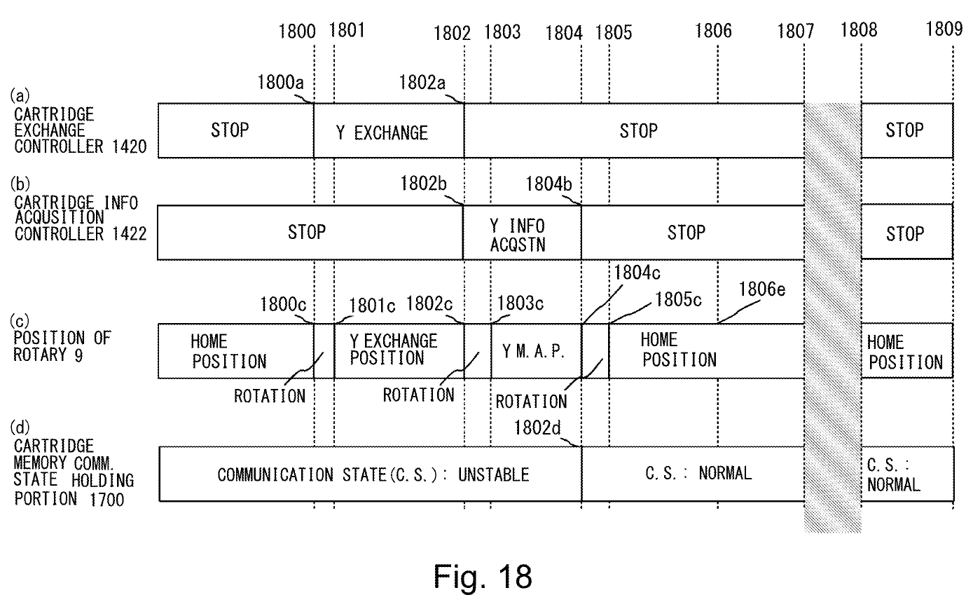

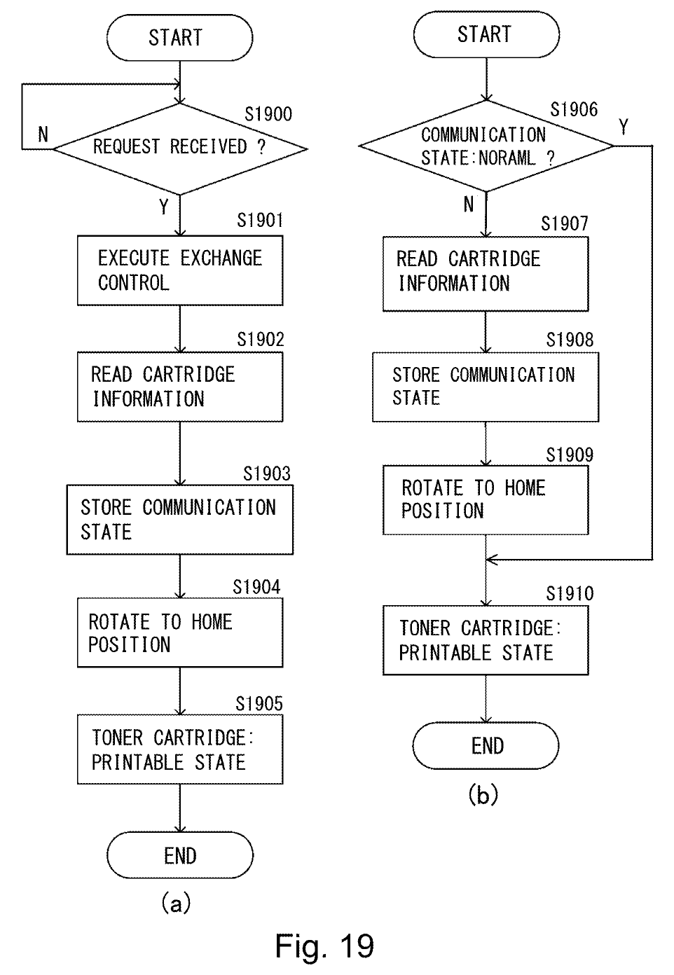

FIG. 17 is a block diagram of the printer main body 1 of the embodiment 2.

When the controller 1400 receives a toner cartridge exchange request from the operating portion 1401 or the host computer 1402, the controller 1400 provides an instruction of the toner cartridge exchange to the engine controller 1403 through a video interface portion 1410. The toner cartridge controller 1412 in the engine controller 1403 provides an instruction to an exchange controller 1420 to exchange the toner cartridge 7 instructed to be exchanged when receives the exchange instruction of the toner cartridge 7 from the video interface portion 1410.

When the exchange instruction of the toner cartridge 7 is provided from the toner cartridge controller 1412, the exchange controller 1420 provides an instruction to a rotary controller 1431 to move the rotary 9 to the exchange position of the exchange-instructed toner cartridge 7. When an instruction to rotate the position of the rotary 9 to the exchange position of the toner cartridge 7 is provided to the rotary controller 1431, the rotary controller 1431 causes a rotary driving portion 1441 of the driving unit 1404 to be driven, so that the rotary 9 is rotated.

The exchange controller 1420 causes the tray driving portion 1440 to be driven when the position of the rotary 9 becomes the exchange position of the toner cartridge 7, so that the tray 8 is slid to a position where the user is capable of exchanging the toner cartridge 7. When the printer main body 1 moves the tray 8 to the exchange position, the user exchanges the toner cartridge 7. Thereafter, completion of the exchange of the toner cartridge 7 is instructed to the printer main body 1 by the user through the operating portion 1401 or the host computer 1402.

When the controller 1400 receives from the operating portion 1401 or the host computer 1402 that the exchange of the toner cartridge is completed, the toner cartridge exchange completion is instructed to the engine controller 1403 through the video interface portion 1410 by the controller 1400. When the toner cartridge controller 1412 in the engine controller 1403 receives the toner cartridge exchange completion through the video interface portion 1410, the toner cartridge exchange completion is instructed to the exchange controller 1420 by the toner cartridge controller 1412. When the exchange controller 1420 receives that the toner cartridge exchange by the user is completed, the exchange controller 1420 causes the driving portion to slide the tray 8 to the inside of the rotary 9.

The toner cartridge controller 1412 provides an instruction to a (cartridge) information acquisition controller 1422 to acquire cartridge information stored in the memory 60 when the exchange of the toner cartridge 7 is completed. The information acquisition controller 1422 provides an instruction to the rotary controller 1431 to rotate the position of the rotary 9 to the memory access position of the toner cartridge 7. When the position of the rotary 9 becomes the memory access position of the toner cartridge 7, the information acquisition controller 1422 accesses the memory 60 through the memory communication controller 1430.

As described with reference to part (a) of FIG. 11, each of the memory 60 and the reading portion 61 is provided with an electrically connectable contact configuration. This electrical connection causes communication abnormality to occur in some instances in the case where the contacts are not satisfactorily ensured or due to an occurrence of electrical noise, or the like. The information acquisition controller 1422 causes the non-volatile memory 1432 to store, through a cartridge memory communication state holding portion 1700, whether communication with the memory 60 is normally ended and necessary information can be acquired or abnormally occurs and the necessary information cannot be acquired. In the following, the cartridge memory communication state holding portion 1700 is referred to as a memory communication state holding portion 1700. The toner cartridge controller 1412 completes the preparation of the toner cartridge 7 after the toner cartridge controller 1412 meets all the toner cartridge exchange requests from the user.

### Description of Timing Chart in Embodiment 2

Timing charts in the embodiment 2 are shown in FIG. 18. FIG. 18 is a timing chart of processing performed in a period until the state of the toner cartridge 7 is put in the printable state after the actuation of the power source of the printer main body 1 in the embodiment 2. In the timing charts of FIG. 18, as an example, an operation after the power source of the printer main body 1 turned off after completion of the exchange of the toner cartridge 7c for yellow will be described. In FIG. 18, part (a) shows the state of the exchange controller 1420, part (b) shows the state of the information acquisition controller 1422, and part (c) shows the position of the rotary 9, and part (d) shows the state of the memory communication state holding portion 1700. Incidentally, 1800 to 1809 represent respective timings. Further, the exchange controller 1420, the information acquisition controller 1422, the rotary 9, and the memory communication state holding portion 1700 are started from "during stop", "during stop", "home position", and "communication state: unstable", respectively.

When the toner cartridge controller 1412 receives a toner cartridge exchange instruction for yellow through the video interface portion 1410, the toner cartridge controller 1412 provides an instruction to the exchange controller 1420 to exchange the toner cartridge for yellow (1800a). When the exchange of the toner cartridge for yellow is instructed the exchange controller 1420 is shifted in state from a state of during stop to Y exchange state and provides an instruction to the rotary controller 1431 to rotate the position of the rotary 9 to the Y exchange position (1800c). The rotary 9 is during rotation in a period from 1800c to 1801c described later.

When the rotary position becomes the Y exchange position (1801c), the exchange controller 1420 causes the driving portion to slide the tray 8y to a position where the user is capable of exchanging the toner cartridge 7y for yellow. When the user exchanges the toner cartridge 7y for yellow, the exchange controller 1420 causes the driving portion to slide the tray 8y to the inside of the rotary 9, so that the state of the rotary 9 is shifted from the Y exchange state to the state during stop (1802a).

When the toner cartridge 7y for yellow is exchanged, the toner cartridge controller 1412 provides an instruction to the information acquisition controller 1422 to acquire cartridge information of the exchanged toner cartridge 7y for yellow (1802b). When the cartridge information acquisition of the toner cartridge 7y for yellow is instructed from the toner cartridge controller 1412, the information acquisition controller 1422 shifts in state from the state during stop to a state during Y information acquisition of the toner cartridge 7y for yellow. In the following, during information acquisition of the toner cartridge 7y for yellow is referred to as during Y information acquisition. The information acquisition controller 1422 provides an instruction to the rotary controller 1431 to rotate the position of the rotary 9 to the memory access position (1802c). The state of the rotary 9 is during rotation in a period from 1802c to 1803c described later.

When the position of the rotary becomes the memory access position (1803c), the information acquisition controller 1422 causes the memory communication controller 1430 to access the memory 60. When the information acquisition controller 1422 is capable of acquiring the cartridge information with no occurrence of communication failure, the information acquisition controller 1422 causes the memory communication state holding portion 1700 to cause the non-volatile memory 1432 to store information which is "normal" as a communication state (1802d).

When the information acquisition controller 1422 acquires the cartridge information (1804b), the state of the information acquisition controller 1422 is shifted from the state of during Y information acquisition to the state during stop. When the information acquisition controller 1422 acquires the cartridge information, the information acquisition controller 1422 provides an instruction to the rotary controller 1431 to rotate the position of the rotary 9 to the home position (1804c). The state of the rotary 9 is during rotation in a period from 1804c to 1805c described later. When the position of the rotary 9 is changed from the memory access position to the home position (1805c), the toner cartridge controller 1412 ends the toner cartridge exchange and puts the state of the toner cartridge 7y in the printable state (1806c).

Thereafter, when removal of an inlet plug 1450 by the user or a power failure occurs, the power source supplying the electric power to the printer main body 1 is turned off (1807). When the printer main body 1 becomes capable of being restored from the state of the power source: OFF by insertion of the inlet plug 1450 or restoration from the state of the power failure, the printer main body 1 performs preparation for being put in the printable state (1808). In the case where the information on the communication state stored in the non-volatile memory 1432 is "normal", the toner cartridge controller 1412 determines that the information acquisition controller 1422 succeeded in acquiring the cartridge information, i.e., that the reading operation is not needed, and puts the toner cartridge 7 in the printable state (1809). Incidentally, in the case where the information on the communication state stored in the non-volatile memory 1432 is not "normal", the toner cartridge controller 1412 determines that the reading operation is needed, so that the reading operation is to be performed.

### Description of Flowchart of Embodiment 2

### Processing During Cartridge Exchange

Parts (a) and (b) of FIG. 19 are flowcharts of the embodiment 2. First, part (a) of FIG. 16 will be described. Part (a) of FIG. 16 is a processing flowchart during the toner cartridge exchange. Incidentally, processing of S1900 to S1902, S1904, and S1905 is similar to the processing of S1600, S1602, S1603, S1605, and S1606, respectively, and will be omitted from description.

In S1903, the information acquisition controller 1422 checks whether or not the cartridge information was capable of being normally acquired in the electrical communication with the memory 60 performed through the memory communication controller 1430. The information acquisition controller 1422 causes the memory communication state holding portion 1700 to cause the non-volatile memory 1432 to store a check result (communication state).

### Processing During Restoration from Power Source: OFF

Next, part (b) of FIG. 19 will be described. Part (b) of FIG. 19 is the flowchart for putting the toner cartridge 7 in the printable state when the printer main body 1 is actuated from the state of power source: OFF. In S1906, the toner cartridge controller 1412 checks the information on the communication state stored in the non-volatile memory 1432 by the memory communication state holding portion 1700. Specifically, the toner cartridge controller 1412 determines whether or not the communication state stored in the non-volatile memory 1432 is "normal".

In the case where the toner cartridge controller 1412 determined in S1906 that the communication state stored in the non-volatile memory 1432 is "normal", the toner cartridge controller 1412 regards the toner cartridge 7 as has already been put in the printable state, and causes the processing to go to S1910. In this case, the above result means that the toner cartridge controller 1412 determined that the reading operation is not needed. In the case where the toner cartridge controller 1412 determined in S1906 that the communication state stored in the non-volatile memory 1432 is "abnormal (failure"), the toner cartridge controller 1412 causes the processing to go to S1907. In this case, the above result means that the toner cartridge controller 1412 determined that the reading operation is needed.

In S1907, the toner cartridge controller 1412 reads the toner cartridge information again from the memory 60 of the toner cartridge 7 of which communication state is "abnormal". Incidentally, as regards the reading of the toner cartridge information, this processing is the same as the processing of S1902 in part (a) of FIG. 19, and therefore, will be omitted from description. Further, processing of S1908 and S1909 is the same as the processing of S1903 and S1904, respectively, described with reference to part (a) of FIG. 19, and therefore, will be omitted.

As described above, in the embodiment 2, the printer main body 1 receives the toner cartridge exchange request from the user, and in the case where the cartridge information is acquired, whether or not the communication with the cartridge memory is normally performed is stored in the non-volatile memory. During the actuation of the printer main body 1, from the information stored in the non-volatile memory, whether or not the acquisition of the toner cartridge information is needed is determined. By this, a time required to acquire the toner cartridge information is minimized, so that it becomes possible to improve usability of the user who intends to perform printing.

In the embodiment 2, although the configuration in which the toner cartridge exchange is instructed from the operating portion 1401 was described, a configuration in which the toner cartridge exchange is instructed from the host computer 1402 or a configuration in which the toner cartridge exchange is toner cartridge exchange is instructed from a portable terminal such as a smartphone via wireless communication may also be employed.

In the embodiment 2, as regards the memory communication state holding portion 1700, description that the communication state for a single color is stored was made, but it is possible to enable holding of the communication state even when communication abnormality (failure) occurs for a plurality of colors. In that case, in the flowchart of part (b) of FIG. 16 during the actuation of the printer main body 1, reading of toner cartridge information for the plurality of stored requested colors is made in some cases.

Further, in this embodiment, whether or not the reading operation is executed on the basis of the presence/absence of the exchange request in the embodiment 1 or whether or not the communication state is normal in the embodiment 2, but the present disclosure is not limited thereto. For example, in the case where in the printer main body 1, an operation in a maintenance mode (predetermined mode) is designated, the information of the non-volatile memory 1432 may be made rewritable from an external device or the like connected to the printer main body 1 through a network or the like. For example, when the operation in the maintenance mode is designated, the toner cartridge controller 1412 causes the non-volatile memory 1432 to store information such as maintenance execution request: YES.

In the case where the information such as maintenance execution request: YES is stored in the non-volatile memory 1432, the information in the non-volatile memory 1432 may be made rewritable from the external device. The toner cartridge controller 1412 may only be required that the rewriting of the information in the non-volatile memory 1432 from the external device is made disable by clearing the maintenance execution request after completion of the maintenance. These are examples of a configuration a change in state of requested information through the external device is permitted in the case where the operation in the predetermined mode is designated.

As described above, according to the embodiment 2, the time required for the operation performed until the state of the toner cartridge becomes the printable state is reduced, so that the usability can be improved.

According to the present disclosure, it is possible to reduce the time required for the operation performed until the state of the toner cartridge becomes the printable state and thus to improve the usability.

### Other Embodiments

The above-described embodiments of the present disclosure can also be realized by a computer of a system or apparatus that reads out and executes computer executable instructions (e.g., one or more programs) recorded on a storage medium (which may also be referred to more fully as a "non-transitory computer-readable storage medium") to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD) TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-021937, filed on February 13, 2025, which is hereby incorporated by reference herein in its entirety.

What is claimed is:

1. An image forming apparatus configured to execute an image forming operation for forming an image on a recording material, the image forming apparatus comprising:
a photosensitive drum;
a plurality of toner cartridges each including a cartridge storing portion in which cartridge information is stored;
a rotary to which the plurality of toner cartridges are detachably mounted, the rotary being rotatable and including a plurality of developing devices each including a developing roller and configured to accommodate toner supplied from corresponding one of the plurality of toner cartridges;
a main body accommodating the rotary and provided with an opening, the main body including a main body storing portion which is a non-volatile memory and is configured to store request information;
a driving device including at least one driving source, the driving device being configured to move each of the plurality of toner cartridges from an inside to an outside of the main body through the opening and configured to rotate the rotary so that the rotary takes an exchange position and a reading position, wherein movement of either one of the plurality of toner cartridges to the outside of the main body is permitted when the rotary is in the exchange position, and a reading operation of the cartridge storing portion of either one of the plurality of toner cartridges is permitted when the rotary is in the reading position;
a reading portion; and
a controller configured to control the driving device and configured to perform the reading operation through the reading portion, the controller determining whether or not the reading operation is executed on the basis of the request information,
wherein in a case where a state of the request information is a first state, the controller takes a preparation state, in which the image forming operation is executable, after the reading operation is executed, and
wherein in a case where the state of the request information is a second state, the controller takes the preparation state without executing the reading operation.

2. The image forming apparatus according to claim 1, wherein the state of the request information is held in a case where a power source of the image forming apparatus is turned off and in a case where the power source of the image forming apparatus is turned on from a turned-off state.

3. The image forming apparatus according to claim 2, wherein the state of the request information is put in the first state in a case where one of the plurality of toner cartridges is moved to the outside of the main body by the driving device.

4. The image forming apparatus according to claim 3, wherein the state of the request information is changed from the first state to the second state in a case where the reading operation is completed for all the plurality of toner cartridges.

5. The image forming apparatus according to claim 1, wherein positions of the plurality of toner cartridges when the rotary takes the preparation state are different from positions of the plurality of toner cartridges when the rotary is in the exchange position.

6. The image forming apparatus according to claim 1, wherein the at least one driving source includes a first driving source for driving the rotary and a second driving source for moving the toner cartridge.

7. The image forming apparatus according to claim 6, wherein the rotary includes a plurality of trays each to which corresponding one of the plurality of toner cartridges is mounted, and each of the plurality of trays is driven by the second driving source so as to be moved to the outside of the main body through the opening.

8. The image forming apparatus according to claim 1, wherein the cartridge information includes information on a kind of each of the plurality of toner cartridges, and the main body storing portion holds the cartridge information read by the reading operation.

9. The image forming apparatus according to claim 1, wherein the controller changes the state of the request information in a case where an operation in a predetermined mode is designated.

10. The image forming apparatus according to claim 1, wherein the controller permits a change in the state of the request information through an external device.

11. An image forming apparatus configured to execute an image forming operation for forming an image on a recording material, the image forming apparatus comprising:
a photosensitive drum;
a plurality of toner cartridges each including a cartridge storing portion in which cartridge information is stored;
a rotary to which the plurality of toner cartridges are detachably mounted, the rotary being rotatable and including a plurality of developing devices each including
a developing roller and configured to accommodate toner supplied from corresponding one of the plurality of toner cartridges;
a main body accommodating the rotary and provided with an opening, the main body including a main body storing portion which is a non-volatile memory and is configured to store request information;
a driving device including at least one driving source, the driving device being configured to move each of the plurality of toner cartridges from an inside to an outside of the main body through the opening and configured to rotate the rotary so that the rotary takes an exchange position and a reading position of each of the plurality of toner cartridges, wherein movement of either one of the plurality of toner cartridges to the outside of the main body is permitted when the rotary is in the exchange position, and a reading operation of the cartridge storing portion of either one of the plurality of toner cartridges is permitted when the rotary is in the reading position;
a reading portion; and
a controller configured to control the driving device and configured to perform the reading operation through the reading portion, the controller determining whether or not the reading operation is executed on the basis of the request information,
wherein in a case where a power source of the image forming apparatus is turned off and in a case where the power source of the image forming apparatus is turned on from a turned-off state, a state of the request information is held, and
wherein in a case where the power source of the image forming apparatus is turned on from the turned-off state after the image forming operation is executed, the controller takes a preparation state, in which the image forming operation is executable, without executing the reading operation.

12. The image forming apparatus according to claim 11, wherein the state of the request information is changed in a case where one of the plurality of toner cartridges is moved to the outside of the main body by the driving device.

13. The image forming apparatus according to claim 11, wherein positions of the plurality of toner cartridges when the rotary takes the preparation state are different from positions of the plurality of toner cartridges when the rotary is in the exchange position.

14. The image forming apparatus according to claim 11, wherein the at least one driving source includes a first driving source for driving the rotary and a second driving source for moving the toner cartridge.

15. The image forming apparatus according to claim 14, wherein the rotary includes a plurality of trays each to which corresponding one of the plurality of toner cartridges is mounted, and each of the plurality of trays is driven by the second driving source so as to be moved to the outside of the main body through the opening.

16. The image forming apparatus according to claim 11, wherein the cartridge information includes information on a kind of each of the plurality of toner cartridges, and the main body storing portion holds the cartridge information read by the reading operation.

17. The image forming apparatus according to claim 11, wherein the controller changes the state of the request information in a case where an operation in a predetermined mode is designated.

18. The image forming apparatus according to claim 11, wherein the controller permits a change in the state of the request information through an external device.
